(19) United States
(12) Patent Application Publication
(10) Pub. No.: US 2007/0058871 A1
(43) Pub. Date: Mar. 15, 2007

(54) Probabilistic wavelet synopses for multiple measures

(75) Inventors: Antonios Deligiannakis, Athens (GR); Minos N. Garofalakis, Morristown, NJ (US); Nick Roussopoulos, Silver Spring, MD (US)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc. and University of Maryland

(21) Appl. No.: 11/225,539

(22) Filed: Sep. 13, 2005

(51) Int. Cl. G06K 9/62; G06F 17/30

(52) U.S. Cl. 382/224; 707/3

(57) ABSTRACT

A technique for building probabilistic wavelet synopses for multi-measure data sets is provided. In the presence of multiple measures, it is demonstrated that the problem of exact probabilistic coefficient thresholding becomes significantly more complex. An algorithmic formulation for probabilistic multi-measure wavelet thresholding based on the idea of partial-order dynamic programming (PODP) is provided. A fast, greedy approximation algorithm for probabilistic multi-measure thresholding based on the idea of marginal error gains is provided. An empirical study with both synthetic and real-life data sets validated the approach, demonstrating that the algorithms outperform naive approaches based on optimizing individual measures independently and the greedy thresholding scheme provides near-optimal and, at the same time, fast and scalable solutions to the probabilistic wavelet synopsis construction problem.

### FIELD OF THE INVENTION

The present invention relates generally to the field of data management and, in particular, relates to approximation.

### BACKGROUND OF THE INVENTION

There is a lot of interest in approximate query and request processing over compact, precomputed data synopses to address the problem of dealing with complex queries over massive amounts of data in interactive decision-support and data-exploration environments. For several of these application scenarios, exact answers are not required and users may, in fact, prefer fast, approximate answers to their queries. Examples include the initial, exploratory drill-down queries in ad-hoc data mining systems, where the goal is to quickly identify the interesting regions of the underlying database, or aggregation queries in decision-support systems, where the full precision of the exact answer is not needed and the first few digits of precision suffice (e.g., the leading digits of a total in the millions or the nearest percentile of a percentage).

Haar wavelets are a mathematical tool for the hierarchical decomposition of functions with several successful applications in signal and image processing. A number of recent studies have also demonstrated the effectiveness of the Haar wavelet decomposition as a data-reduction tool for database problems, including selectivity estimation and approximate query and request processing over massive relational tables and data streams. Briefly, the decomposition process is applied over an input data set along with a thresholding procedure in order to obtain a compact data synopsis comprising a selected small set of Haar wavelet coefficients. Several research studies have demonstrated that fast and accurate approximate query and request processing engines can be designed to operate solely over such precomputed compact wavelet synopses.

The Haar wavelet decomposition was originally designed with the objective of minimizing the overall root-mean-squared error (i.e., the L₂-norm) in the data approximation. However, recent work on probabilistic wavelet synopses also demonstrates their use for optimizing other error metrics, including the maximum relative error in the approximate reconstruction of individual data values, which is a metric for query answers and enables meaningful, non-trivial error guarantees for reconstructed values. While the use of the traditional Haar wavelet decomposition gives the user no knowledge on whether a particular answer is highly-accurate or off by many orders of magnitude, the use of probabilistic wavelet synopses provides the user with an interval where the exact answer is guaranteed to lie into.

Despite the surge of interest in wavelet-based data reduction and approximation in database systems, relatively little attention has been paid to the application of wavelet techniques to complex tabular data sets with multiple measures (multiple numeric entries for each table cell.) Such massive, multi-measure tables arise naturally in several application domains, including online analytical processing (OLAP) environments and time-series analysis/correlation systems. As an example, a corporate sales database may tabulate, for each available product, (1) the number of items sold, (2) revenue and profit numbers for the product, and (3) costs associated with the product, such as shipping and storage costs. Similarly, a network-traffic monitoring system takes readings on each time-tick from a number of distinct elements, such as routers and switches, in the underlying network and typically several measures of interest need to be monitored (e.g., input/output traffic numbers for each router or switch interface) even for a fixed-network element.. Both of these types of applications may be characterized not only by the potentially very large domain sizes for some dimensions (e.g., several thousands of time ticks or different products sold), but also by the huge amounts of collected data.

Recently, the idea of extended-wavelet coefficients was introduced as a flexible, space-efficient storage format for extending conventional wavelet-based summaries to the context of multi-measure data sets. However, the synopsis-construction techniques can only be used to minimize (for a given space budget) the weighted sum of the overall L₂-norm errors for each measure. Still, given the pitfalls and shortcomings of L₂-error-optimized wavelet synopses for building effective approximate query processing engines, there is a clear need for more sophisticated wavelet-based summarization techniques for multi-measure data that can be specifically optimized for different error metrics (such as the relative error metric).

### SUMMARY

Various deficiencies of the prior art are addressed by various exemplary embodiments of the present invention of probabilistic wavelet synopsis for multiple measures, including algorithms for constructing effective probabilistic wavelet-synopses over multi-measure data sets and techniques that can accommodate a number of different error metrics, including the relative-error metric, thus enabling meaningful error guarantees on the accuracy of the approximation for individual measure values. By operating on all measures simultaneously, exemplary embodiments judiciously allocate the available space to all measures based on the difficulty of accurately approximating each one, and exploit storage dependencies among coefficient values to achieve improved storage utilization and, therefore, improve accuracy in data reconstruction over prior techniques that operate on each measure individually.

One embodiment is a method for probabilistic wavelet synopses for data sets with multiple measures. In response to a request, a wavelet synopsis is constructed that minimizes an error metric for a data domain having multiple measures. The wavelet synopsis includes extended wavelet coefficients. Space is allocated by applying a probabilistic thresholding technique that is based on unbiased randomized rounding of the extended wavelet coefficients. The probabilistic thresholding includes accounts for storage dependencies among the extended wavelet coefficients and selects rounding values such that the error metric is minimized, while not exceeding a prescribed space limit for the probabilistic wavelet synopsis. An approximation in response to the request is provided.

Another embodiment is a method for probabilistic wavelet synopses for multiple measures, where a synopsis space is allocated to extended wavelet coefficients in an error tree based on marginal error gains by, at each step, attempting to allocate additional space to a subset of the extended wavelet coefficients that results in a largest reduction in a maximum normalized standard error (NSE²) per unit of space used. Estimated current and potential maximum NSE² values are calculated at a root coefficient of the error tree for each data measure and an approximation to the maximum minimization problem for the extended wavelet coefficients is provided.

### BRIEF DESCRIPTION OF THE DRAWINGS

The teachings of the present invention can be readily understood by considering the following detailed description in conjunction with the accompanying drawings, in which:

FIG. 1 depicts an error tree for an exemplary array;

FIG. 2 depicts an example of partial-order pruning;

FIG. 3 depicts an example for an exemplary embodiment of a greedy approximation (GreedyRel) algorithm;

FIGS. 4A and 4B are a flow chart for an exemplary embodiment of a compute subroutine;

FIG. 5 is a flow chart for an exemplary embodiment of a partial order dynamic programming (PODP) algorithm;

FIG. 6 is a flow chart for an exemplary embodiment of a GreedyRel algorithm;

FIG. 7 is a flow chart of an exemplary embodiment of a traverse subroutine, which is called in the GreedyRel algorithm of FIG. 6;

FIGS. 8, 9, 10, 11, 12, 13, 14, 15, 16, 17, 18, 19, and 20 are charts showing experimental results from a study of exemplary embodiments of the present invention; and

FIG. 21 is a high-level block diagram showing a computer. To facilitate understanding, identical reference numerals have been used, where possible, to designate identical elements that are common to the figures.

### DETAILED DESCRIPTION OF THE INVENTION

The invention will be primarily described within the general context of an embodiment of wavelet synopses for multiple measures, however, those skilled in the art and informed by the teachings herein will realize that the invention is applicable to approximation, uncertainty, and probabilistic databases, benchmarking and performance evaluation, data cleaning, transformation, migration, and lineage, data mining and knowledge discovery, data models, semantics, and query languages, data privacy and security, data stream and publish-subscribe systems, data warehousing and OLAP, digital libraries, embedded, sensor, and mobile databases, metadata management, middleware and workflow management, multimedia databases, optimization, performance, availability, and reliability, parallel, distributed, and heterogeneous databases, peer-to-peer and networked data management, personalized information systems, physical database design, indexing, and tuning, replication, caching, and view management, scientific, biological, and statistical databases, spatial, temporal, and real-time databases, storage and transaction management, text databases and information retrieval, user interfaces and data visualization, web information and Web services, extensible markup language (XML) and semi-structured databases and many different kinds of data management.

Probabilistic Wavelets over Multiple Measures

Formulation and Exact PODP Solution

The problem of constructing probabilistic wavelet synopses over multi-measure data sets using the space-efficient extended wavelet coefficient format is formally defined below. Utilizing this more involved storage format for coefficients forces non-trivial dependencies between thresholding decisions made across different measures, thus significantly increasing the complexity of probabilistic coefficient thresholding. More specifically, these dependencies cause the principle of optimality based on a total ordering or partial solutions that is required by the earlier single-measure dynamic programming (DP) solutions to be violated, rendering these techniques inapplicable in the multi-measure setting. Thus, exemplary embodiments include a probabilistic thresholding scheme for multi-measure data sets based on the idea of an exact partial-order DP (PODP) formulation. Briefly, the PODP solution generalizes earlier single-measure DP schemes to data sets with M measures by using an M-component vector objective and an M-component less-than partial order to prune sub-problem solutions that cannot possibly be part of an optimal solution.

Fast, Greedy Approximate Probabilistic-Thresholding Algorithm

Given the very high space and time complexities of exemplary embodiments of the PODP algorithm, an exemplary embodiment of a novel, greedy approximation algorithm (GreedyRel) is used for probabilistic coefficient thresholding over multi-measure data. Briefly, the GreedyRel heuristic exploits the error-tree structure for Haar wavelet coefficients in greedily allocating the available synopsis space based on the idea of marginal error gains. More specifically, at each step, GreedyRel identifies for each error subtree, the subset of wavelet coefficients that are expected to give the largest per-space reduction in the error metric, and allocates space to the best such subset overall (i.e., in the entire tree). The time and space complexities of the GreedyRel are only linear in the number of measures involved and the data-set size and, in fact, are also significantly lower than those of earlier DP algorithms for the single-measure case. Note that the complexities of the earlier DP algorithms are, even for the single-measure case, at least quadratic to the domain size, thus yielding the GreedyRel algorithms as a practical solution, even for the single-measure case, for constructing accurate probabilistic wavelet synopses over large data sets.

Experimental Results Verifying the Effectiveness of the Approach

Results from an extensive experimental study of exemplary embodiments are provided with both synthetic and real-life data sets. The results validate the approach, demonstrating that (1) the algorithms easily outperform naive approaches based on optimizing individual measures independently, typically producing errors that are up to a factor of seven smaller than prior techniques; and (2) the greedy thresholding scheme provides near-optimal and, at the same time, very fast and scalable solutions to the probabilistic wavelet synopsis construction problem.

The Haar Wavelet Transform

Wavelets are a useful mathematical tool for hierarchically decomposing functions in ways that are both efficient and theoretically sound. Broadly speaking, the wavelet decomposition of a function consists of a coarse overall approximation along with detail coefficients that influence the function at various scales. Suppose the one-dimensional data vector A is given with A containing the N=8 data values A=[2,2,0,2,3,5,4,4]. The Haar wavelet transform of A can be computed as follows. First, the values are averaged together pairwise to get a new lower-resolution representation of the data with the following average values [2,1,4,4]. In other words, the average of the first two values (that is, 2 and 2) is 2 that of the next two values (that is, 0 and 2) is 1, and so on. Some information has been lost in this averaging process. To be able to restore the original values of the data array, some detail coefficients are stored that capture the missing information. In Haar wavelets, these detail coefficients are simply the differences of the (second of the) averaged values from the computed pairwise average. Thus, in the simple example, for the first pair of averaged values, the detail coefficient is 0 since 2−2=0, for the second we again need to store −1 since 1−2=−1. Note that no information has been lost in this process—it is fairly simple to reconstruct the eight values of the original data array from the lower-resolution array containing the four averages and the four detail coefficients. Recursively applying the above pairwise averaging and differencing process on the lower-resolution array containing the averages, the following full decomposition is obtained.

| Resolution | Averages | Detail Coefficients |
|---|---|---|
| 3 | [2, 2, 0, 2, 3, 5, 4, 4] | — |
| 2 | [2, 1, 4, 4] | [0, −1, −1, 0] |
| 1 | [ 3/2, 4] | [½, 0] |
| 0 | [1¼] | [− 5/4] |

The wavelet transform (also known as the wavelet decomposition) of A is the single coefficient representing the overall average of the data values followed by the detail coefficients in the order of increasing resolution. Thus, the one-dimensional Haar wavelet transform of A is given by W_{A}=[11/4, −5/4,1/2,0,0,−1,−1,0]. Each entry in W_{A} is called a wavelet coefficient. The main advantage of using W_{A} instead of the original data vector A is that for vectors containing similar values most of the detail coefficients tend to have very small values. Thus, eliminating such small coefficients from the wavelet transform (i.e., treating them as zeros) introduces only small error when reconstructing the original data, resulting in a very effective form of lossy data compression. Furthermore, the Haar wavelet decomposition can also be extended to multi-dimensional data arrays through natural generalizations of the one-dimensional decomposition process described above. Multi-dimensional Haar wavelets have been used in a wide variety of applications, including approximate query answering over complex decision-support data sets.

Error Tree and Conventional Wavelet Synopses

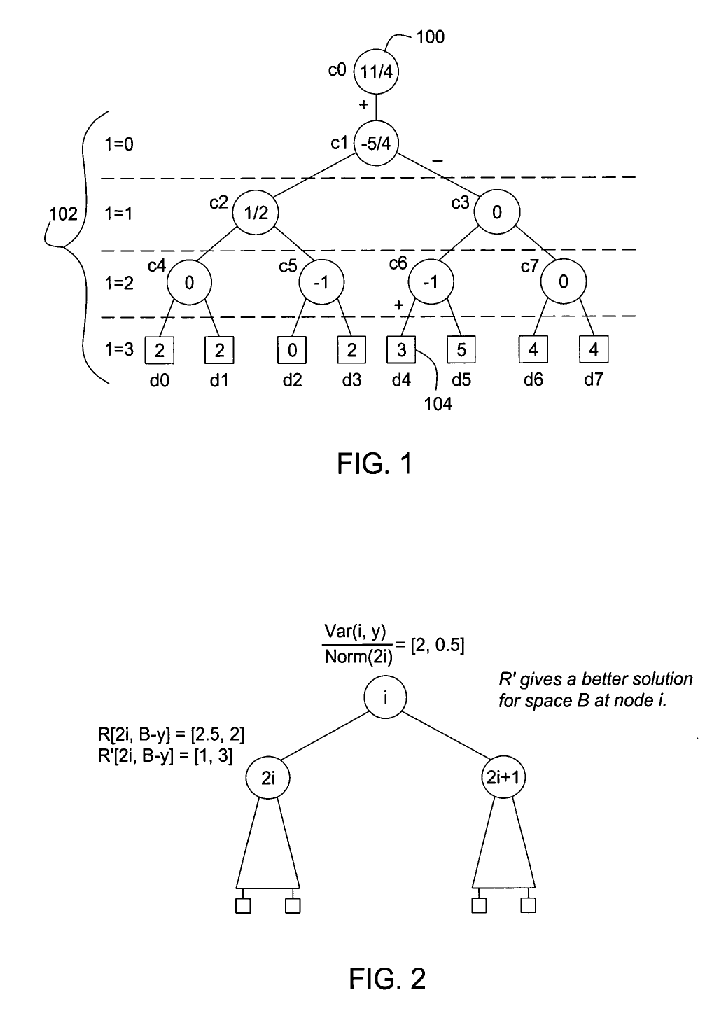

A helpful tool for exploring the properties of the Haar wavelet decomposition is the error tree structure, which is a hierarchical structure built based on the wavelet transform process. FIG. 1 depicts the error tree for the example data vector A. Each internal node cᵢ (i =0, . . . , 7) is associated with a wavelet coefficient value and each leaf dᵢ (i =0, . . . , 7) is associated with a value in the original data array; in both cases, the index/coordinate i denotes the positions in the data array or error tree. For example, c₀ 100 corresponds to the overall average of A. The resolution levels I 102 for the coefficients (corresponding to levels in the tree) are also depicted. The terms node and coefficient are used interchangeably in what follows. Table 1 summarizes some notational conventions. Additional notation is introduced as necessary and detailed symbol definitions are also provided at appropriate locations in the text.

TABLE 1
Notation

| | Description |
|---|---|
| | i ε{0, . . . , N − 1}, j ε {1, . . . , M}, |
| Symbol | j index/subscript is dropped for M = 1 |
| N | Number of data-array cells |
| D | Data-array dimensionality |
| M | Number of data-set measures |
| B | Space budget for synopsis |
| A, W_{A} | Input data and wavelet transform arrays |
| dᵢⱼ | Data values for i^{th} cell and j^{th} measure of data array |
| \hat{d}ᵢⱼ | Reconstructed data value for i^{th} cell and j^{th} measure |
| Cᵢⱼ | Haar coefficient at coordinate i for the j^{th} measure |
| yᵢⱼ | Retention probability (i.e., fractional storage) for |
| | Haar coefficient cᵢⱼ |
| Cᵢⱼ | Random variable for Haar coefficient cᵢⱼ |
| ECᵢ | Extended wavelet coefficient at coordinate i |
| Norm(i, j) | Normalization term for Haar coefficient cᵢⱼ |
| q | Integer quantization parameter |
| NSE(\hat{d}ᵢⱼ) | Normalized term for Haar coefficient cᵢⱼ |
| Var(cᵢⱼ, yᵢⱼ) | Variance of cᵢⱼ for a given space yᵢⱼ |
| path(u) | All non-zero proper ancestors of u in the error tree |

Given a node u in an error tree T, let path(u) denote the set of all proper ancestors of u in T (i.e., the nodes on the path from u to the root of T, including the root but not u) with non-zero coefficients. A property of the Haar wavelet decomposition is that the reconstruction of any data value dᵢ depends only on the values of coefficients on path(dᵢ); more specifically, dᵢ=Σ_{c}_{ⱼ}_{∈path(d}_{ᵢ}₎ δᵢⱼ·cⱼ, where δᵢⱼ=+1 is in the left child subtree of cⱼ j=0, and δᵢⱼ=−1 otherwise. for example, for d₄ 104 in FIG. 1,

$${d}_{4} = {c}_{0} - {c}_{1} + {c}_{6} = \frac{11}{4} - ( - \frac{5}{4} ) + ( - 1 ) = 3.$$

The support region for a coefficient cᵢ is defined as the set of (contiguous) data values that cᵢ is used to reconstruct; the support region for a coefficient cᵢ is uniquely identified by its coordinate i.

Given a limited amount of storage for building a wavelet synopsis of the input data array A, a thresholding procedure retains a certain number B<<N of the coefficients as a highly-compressed approximate representation of the original data (the remaining coefficients are implicitly set to 0). Conventional coefficient thresholding is a deterministic process that seeks to minimize the overall root-mean-squared error (L₂ error norm) of the data approximation by retaining the B largest wavelet coefficients in absolute normalized value. L₂ coefficient thresholding has also been the method of choice for the bulk of existing work on Haar-wavelets applications in the data-reduction and approximate query processing domains.

Probabilistic Wavelet Synopses

Unfortunately, wavelet synopses optimized for overall L₂ error using the above-described process may not always be the best choice for approximate query processing systems. Such conventional wavelet synopses suffer from several problems, including the introduction of severe bias in the data reconstruction and wide variance in the quality of the data approximation, as well as the lack of non-trivial guarantees for individual approximate answers. A probabilistic wavelet synopsis addresses these shortcomings. This approach constructs data summaries from wavelet-transform arrays. In a nutshell, the idea is to apply a probabilistic thresholding process based on randomized rounding that randomly rounds coefficients either up to a larger rounding value or down to zero, so that the value of each coefficient is correct on expectation. More formally, each non-zero wavelet coefficient cᵢ is associated with a rounding value λ and a corresponding retention probability yᵢ=cᵢ/λᵢ such that 0<yᵢ≦1 and the value of coefficient cᵢ in the synopsis becomes a random variable Cᵢ∈{0, λᵢ}, where
Cᵢ={λᵢ with probability yᵢ,
0 with probability 1−yᵢ}
In other words, a probabilistic wavelet synopsis essentially rounds each non-zero wavelet coefficient cᵢ independently to either λᵢ or zero by flipping a biased coin with success probability yᵢ. Note that the above rounding process is unbiased; that is, the expected value of each rounded coefficient is E[Cᵢ]=λᵢ ·yᵢ +0 ·(1 −yᵢ) =cᵢ, i.e., the actual coefficient value, while its variance is

$$Var ( i , {y}_{i} ) = Var ( {C}_{i} ) = ( {λ}_{i} - {c}_{i} ) \cdot {c}_{i} = \frac{1 - {y}_{i}}{{y}_{i}} \cdot {c}_{i}^{2} \qquad ( 1 )$$

and the expected size of the synopsis is simply

$$E 〚 synopsis 〛 = {\sum }_{i \vert {c}_{i} \neq 0} {y}_{i} = {\sum }_{i \vert {c}_{i} \neq 0} \frac{{c}_{i}}{{λ}_{i}} .$$

Thus, since each data value can be reconstructed as a simple linear combination of wavelet coefficients and, by linearity of expectation, it is easy to see that probabilistic wavelet synopses guarantee unbiased approximations of individual data values as well as range-aggregated query answers.

There are several different algorithms for building probabilistic wavelet synopses. The coefficient rounding values {λᵢ} need to be selected such that some desired error metric for the data approximation is minimized, while not exceeding a prescribed space limit B for the synopsis (i.e., E[[synopsis]]≦B ). These strategies are based on formulating appropriate dynamic-programming (DP) recurrences over the Haar error-tree that explicitly minimize either (a) the maximum normalized standard error (MinRelVar) or (b) the maximum normalized bias (MinRelBias) for each reconstructed value in the data domain. The rationale for these probabilistic error metrics is that they are directly related to the maximum relative error (with an appropriate sanity bound s, whose role is to ensure that relative-error numbers are not unduly dominated by small data values in the approximation of individual data values based on the synopsis; that is, both the MinRelVar and MinRelBias schemes try to (probabilistically) control the quantity

$${max}_{i} \{ \frac{\vert {\hat{d}}_{i} - {d}_{i} \vert}{max \{ \vert {d}_{i} \vert , S \}} \} ,$$

where \hat{d}ᵢ denotes the data value reconstructed based on the wavelet synopsis. Note, of course, that \hat{d}ᵢ is again a random variable, defined as the ±1 summation of all (independent) coefficient random variables on path(d). Bounding the maximum relative error in the approximation also allows for meaningful error guarantees to be provided on reconstructed data values.

To accomplish this, the DP algorithms seek to minimize the maximum normalized standard error (NSE) in the data reconstruction, defined as

$${max }_{i} NSE ( {\hat{d}}_{i} ) = {max}_{i} \frac{\sqrt{Var ( {\hat{d}}_{i} )}}{max \{ \vert {d}_{i} \vert , s \}}$$

where Var(\hat{d}ᵢ)=Σ_{cj∈path (d)}Var(j,yⱼ). The algorithms also naturally extend to multi-dimensional data and wavelets, with a running time of O(N_{z}2^{D}qB(qlog(qB)+D2^{D})) (N_{z} being the number of nodes with at least one non-zero coefficient value, N being the maximum domain size and D being the number of dimensions), an overall space requirement of O(N_{z}2^{D}qB) and an in-memory working-set size of O(2^{D}qB log N). Note that for synopsis spaces B=O(N_{z}), the above running time and space complexities are at least quadratic to the number of tuples.
Extended Wavelet Coefficients

The wavelet coefficients can be stored as tuples with D+1 fields, where D is the dimensionality of the data array. Each of these tuples contains the D coordinates of the stored wavelet coefficient (one per dimension), which are used to determine the coefficient's support region, and the stored coefficient value. In multi-measure data sets, storage dependencies among different coefficient values may arise. This occurs because two or more coefficient values for different measures may correspond to the same coefficient coordinates, which results in duplicating the storage of these coordinates. This storage duplication increases with the number of the data set's dimensions due to the increased size of the coefficient coordinates.

To alleviate these shortcomings, the notion of an extended wavelet coefficient is introduced. For a data set comprising M measures, an extended wavelet coefficient is a flexible, space-efficient storage format that can be used to store any subset of up to M coefficient values for each combination of coefficient coordinates. Briefly, this is achieved through the use of a bitmap of size M, which helps determine exactly the subset of coefficient values that has been stored; thus, the i^{th} bitmap bit is set if and only if the coefficient for the i^{th} measure has been stored (1 ≦i ≦M ). More formally, each extended wavelet coefficient is defined as a triplet (C,β, V) consisting of (1) the coordinates C of the coefficient; (2) a bitmap β of size M, where the i^{th} bit denotes the existence or absence of a coefficient value for the ith measure; and (3) the set of stored coefficient values V. The (coordinates, bitmap) pair is referred to as the coefficient's header for an extended wavelet coefficient.

Probabilistic Wavelets for Multiple Measures

Problem Formulation and Overview

It has been demonstrated that exploiting storage dependencies among coefficient values can lead to better storage utilization (i.e., store more useful coefficient values for the same space bound) and, therefore, improve accuracy to queries. However, those algorithms can only be applied towards minimizing the overall L₂ error of the approximation, not for minimizing other error metrics, such as the maximum relative error, which is relevant for providing approximate query answers. On the other hand, while the known work utilized the notion of probabilistic wavelet synopses to propose algorithms that minimize the maximum relative error of the approximation, none of these algorithms can exploit storage dependencies between coefficient values to construct effective probabilistic wavelet synopses for multi-measure data sets.

In exemplary embodiments of the present invention, the notion of the extended wavelet coefficients and the probabilistic wavelet synopses are utilized as helpful tools to develop algorithms that seek to minimize the maximum relative error of the approximation in multi-measure data sets. To simplify the exposition, this description first focuses primarily on the one-dimensional case and then extensions to multi-dimensional wavelets are described.

Expected Size of Extended Coefficients

The sharing of the common header space (i.e., coordinates+bitmap) among coefficient values introduces non-trivial dependencies in the thresholding process across coefficients for different measures. To be more precise, consider a data set with M measures and let cᵢⱼ denote the Haar coefficient value corresponding to the j^{th} measure at coordinate i and let yᵢⱼ denote the retention probability for cᵢⱼ in the synopsis. Also, let ECᵢ be the extended wavelet coefficient at coordinate i and let H denote the space required by an extended coefficient header. The unit of space is set equal to the space required to store a single coefficient value (e.g., size of a float) and all space requirements are expressed in terms of this unit. The expected space requirement of the extended coefficient ECᵢ is computed as:

$$E 〚 {EC}_{i} 〛 = {\sum }_{j \vert {c}_{ij} \neq 0} {y}_{ij} + H \times ( 1 - {\prod }_{j = 1}^{M} ( 1 - {y}_{ij} ) ) \qquad ( 2 )$$

The first summand in the above formula captures the expected space for all (non-zero) individual coefficient values at coordinate i. The second summand captures the expected header overhead. To see this, note that if at least one coefficient value is stored, then a header space of H must also be allotted. And, of course, the probability of storing ≧1 coefficient values is just one minus the probability that none of the coefficients is stored.

Equation (2) demonstrates that the sharing of header space amongst the individual coefficient values cᵢⱼ for different measures creates a fairly complex dependency of the overall extended-coefficient space requirement on the individual retention probabilities yᵢⱼ. Given a space budget B for the wavelet synopsis, exploiting header-space sharing and this storage dependency across different measures is crucial for achieving effective storage utilization in the final synopsis. This implies that the exemplary embodiments of the probabilistic-thresholding strategies for allocating synopsis space cannot operate on each measure individually; instead, space allocation explicitly accounts for the storage dependencies across groups of coefficient values (corresponding to different measures). This significantly complicates the design of probabilistic-thresholding algorithms for extended wavelet coefficients.

Problem Statement and Approach

A goal is to minimize the maximum relative reconstruction error for each individual data value; this also allows exemplary embodiments to provide meaningful guarantees on the accuracy of each reconstructed value. More formally, an aim is to produce estimates \hat{d}ᵢⱼ of the data values dᵢⱼ, for each coordinate i and measure index j, such that |\hat{d}ᵢⱼ−dᵢⱼ|≦ε·max {|dᵢⱼ|, sⱼ}, for given per-measure sanity bounds sⱼ>0, where the error bound ε>0 is minimized subject to the given space budget for the synopsis. Since probabilistic thresholding implies that \hat{d}ᵢⱼ is again a random variable, and using an argument based on the Chebyshev bound, it is easy to see that minimizing the overall NSE across all measures (or equivalently, the maximum NSE²) guarantees a maximum relative error bound that is satisfied with high probability. Thus, the probability-thresholding problem may be defined for extended wavelet coefficients as follows.

Maximum NSE Minimization for Extended Coefficients

Find the retention probabilities yᵢⱼ for coefficients cᵢⱼ that minimize the maximum NSE for each reconstructed data value across all measures; that is,

$$\begin{matrix} & max & \frac{\sqrt{Var ( {\hat{d}}_{i} )}}{max \{ \vert {d}_{ij} \vert , {s}_{j} \}} \\ minimize & i ∈ \{ 0 , … , N - 1 \} & \\ & j ∈ \{ 0 , … , M \} & \end{matrix} \qquad ( 3 )$$

subject to the constraints 0 <yᵢⱼ ≦1 for all non-zero cᵢⱼ and E[[synopsis ]]=Σᵢ]≦B , where the expected size E[[ECᵢ]]of each extended coefficient is given by equation (2).

The above maximum NSE minimization problem for multi-measure data is addressed by exemplary embodiments of the present invention. Exemplary embodiments of algorithms exploit both the error-tree structure of the Haar decomposition and the above-described storage dependencies (equation (2)) for extended coefficients in order to intelligently assign retention probabilities {yᵢⱼ} to non-zero coefficients within the overall space-budget constraint B. The exemplary embodiments also rely on quantizing the space allotments to integer multiples of 1/q, where q>1 is an integer input parameter; that is, the constraint

$$0 < {y}_{ij} \leq 1 to {y}_{ij} ∈ \{ \frac{1}{q} , \frac{2}{q} , … , 1 \}$$

is modified in the above problem formulation.
An Algorithm Formulation: Partial-Order Dynamic Programming

Consider an input data set with M measures. An exemplary embodiment of the present invention includes a partial-order dynamic programming (PODP) algorithm that processes the nodes in the error tree bottom-up and calculates for each node i and each space budget 0≦Bᵢ≦B to be allocated to the extended wavelet coefficient values in the node's entire subtree, a collection of incomparable solutions. Each such solution R[i, Bᵢ] is an M-component vector of NSE² values corresponding to all M measures for the data values in the subtree rooted at node i and assuming a total space of Bᵢ allotted to extended coefficients in that subtree. A goal of the PODP algorithm is, of course, to minimize the maximum component of the vector R[root,B]; that is, minimize max_{k=1, . . . ,M}{R[root,B]ₖ}.

A complication in the optimization problem is that, for a given synopsis space budget, these M per-measure NSE values are not independent and cannot be optimized individually; this is, again, due to the intricate storage dependencies that arise between the approximation at different measures because of the shared header space (equation (2)). As already described, the thresholding algorithm exploits these dependencies to ensure effective synopsis-space utilization. This implies that the thresholding schemes need to treat these M-component NSE vectors as a unit during the optimization process.

Let dₘ_{₂ᵢⱼ} denote the minimum absolute data value in the subtree of node 2i and let Norm(21, j) =max {d²ₘᵢₙ_{_{2i,j}},S²ⱼ } denote a normalization term of the j^{th} measure for node's i left subtree, with the corresponding normalization term of the right tree defined similarly. It can be proved that the j^{th} component of R[i,B] produced by the optimal assignment of retention probabilities to the coefficient values in the subtree of node i is determined by the minimum absolute data value of measure j in the subtree. This enables a simplification of the minimization problem of equation (3) by utilizing at each node the normalization terms of its subtrees. The j^{th} component of R[i,B] at node i for a given retention probability yᵢⱼ of the cᵢⱼ coefficient value and solutions R[2i,b₂ᵢ] and R[2i+1, b₂ᵢ+₁] from the node's left and right subtrees, can thus be calculated as

$$max \{ \begin{matrix}\frac{Var ( i , {y}_{ij} )}{Norm ( 2 i , j )} + \\ R [ 2 i , {b}_{2 i} ] [ j ] , \frac{Var ( i , {y}_{ij} )}{Norm ( 2 i + 1 , j} + \\ R [ 2 i + 1 , {b}_{2 i + 1} ] [ j ]\end{matrix} \}$$

To ensure optimality, the bottom-up computation of the DP recurrence cannot afford to maintain just the locally-optimal partial solution for each subtree. In other words, merely tabulating the R[i,B] vector with the minimum maximum component for each internal tree node and each possible space allotment is not sufficient—more information needs to be maintained and explored during the bottom-up computation. As a simple example, consider the scenario depicted in FIG. 2 for the case M =2. Slightly abusing notation, R[2i,B −y]and R′[2i,B−y]denote two possible NSE² vectors for space B-y at node 2i. To simplify the example, assume that the right child of node i also gives rise to the exact same solution vectors R▭and R′▭. In FIG. 2, the normalized variance

$$\frac{Var ( i , {y}_{ij} )}{Norm ( 2 i , j )}$$

of the coefficient values of node i are depicted when total space y=yᵢₗ +yᵢ₂ has been allocated to them and for the data values in the left subtree of node i. It is easy to see that, in this example, even though R′[2i,B−y] is locally-suboptimal at node 2i (because its maximal component is larger than the one of R▭), it gives a superior overall solution of [1+2,3+0.5]=[3,3.5] at node i, when combined with i's local variance vector.

In the exemplary embodiment of the PODP algorithm, unlike most other DP solutions, the conventional principle of optimality based on a total ordering of partial solutions is no longer applicable. Thus, locally-suboptimal R[i,B]'s (i.e., with large maximum component NSE²s) cannot be safely pruned, because they may, in fact, be part of an optimal solution higher up in the tree. However, there does exist a safe pruning criterion based on a partial ordering of the R[i,B] vectors defined through the M-component less-than operator [symbol] =_{M}, which is defined over M-component vectors u,v as follows:
u [symbol] =_{M}νif and only if u_{i≦ν}ᵢ, ∀i ∈{1, . . . ,M}.
For a given coordinate i and space allotment B, we say that a partial solution R′[i,B] is covered by another partial solution R[i,B] if and only if R[i,B] [symbol] =_{M} R′[i,B]. It is easy to see that, in this case, R′[i,B] can be safely pruned from the set of partial solutions for the (i,B) combination, because, intuitively, R[i,B] can always be used in its place to give an overall solution of at least as good quality.

In the exemplary embodiment of the partial-order dynamic programming (PODP) solution to the maximum NSE minimization problem for extended coefficients, the partial, bottom-up computed solutions R[i,B] are M-component vectors of per-measure NSE² values for coefficient subtrees and such partial solutions are only pruned based on the [symbol] =_{M} partial order. Thus, for each coordinate-space combination (i,B), the exemplary embodiment of the PODP algorithm tabulates a collection R[i,B] of incomparable solutions, that represent the boundary points of [symbol] =_{M},
R[i,B]={R[i,b]:for any other R′[i,B]∈R[i,B]}, R[i,b] [symbol] ≠_{M}R′[i,B]and R′[i,b] [symbol] ≠_{M}R[i,B]
Of course, for each allotment of space B to the coefficient subtree rooted at node i, the exemplary embodiment of the PODP algorithm needs to iterate over all partial solutions computed in R[i,B] in order to compute the full set of (incomparable) partial solutions for node i's parent in the tree. Similarly, at leaves or intermediate root nodes, all possible space allotments {yᵢⱼ} to each individual measure are considered and the overall space requirements of the extended coefficient are estimated using equation (2). Using an integer parameter q>1 to quantize possible space allotments introduces some minor complications with respect to the shared header space (e.g., some small space fragmentation) that the exemplary embodiment of the algorithm handles.

The main drawback of the exemplary embodiment of the PODP-based solution is the dramatic increase in time and space complexity compared to the single-measure case. PODP relies on a much stricter, partial-order criterion for pruning suboptimal solutions that implies that the sets of incomparable partial solutions R[i,B} that need to be stored and explored during the bottom-up computation can become very large. For instance, in the simple case of a leaf coefficient, it is easy to see that the number of options to consider can be as high as O(q^{M}), compared to only O(q) in the single-measure case; furthermore, this number of possibilities can grow extremely fast (in the worst case, exponentially) as partial solutions are combined up the error tree.

A Fast, Greedy, Approximation Algorithm

Given the very high running-time and space complexities of the exemplary embodiment of the PODP-based solution described above, an exemplary embodiment of an effective approximation algorithm to the maximum NSE minimization problem for extended coefficients is provided. This exemplary embodiment is a very efficient, greedy, heuristic algorithm (termed GreedyRel) for this optimization problem. Briefly, GreedyRel tries to exploit some of the properties of dynamic-programming solutions, but allocates the synopsis space to extended coefficients greedily based on the idea of marginal error gains. An idea is to try, at each step, to allocate additional space to a subset of extended wavelet coefficients in the error tree that results in the largest reduction in the target error metric (i.e., maximum NSE²) per unit of space used.

The exemplary embodiment of the GreedyRel algorithm relies on three operations: (1) estimating the maximum per-measure NSE² values at any node of the error tree; (2) estimating the best marginal error gain for any subtree by identifying the subset of coefficients in the subtree that are expected to give the largest per-space reduction in the maximum NSE²; and (3) allocating additional synopsis space to the best overall subset of extended coefficients (in the entire error tree). Let Tᵢⱼ denote the error subtree (for the j^{th}measure) rooted at cᵢⱼ .

Estimating Maximum NSE² at Error-Tree Nodes

In order to determine the potential reduction in the maximum squared NSE due to extra space, the exemplary embodiment of GreedyRel first needs to obtain an estimate for the current maximum NSE² at any error-tree node. GreedyRel computes an estimated maximum NSE² G[i,j] over any data value for the j^{th} measure in the Tᵢⱼ subtree, using the recurrence:

$$G [ i , j ] = \{ max \{ \frac{Var ( {c}_{ij} , {y}_{ij} )}{Norm ( 2 i , j )} + G [ 2 i , j ] , \\ \frac{Var ( {c}_{ij} , {y}_{ij} )}{Norm ( 2 i + 1 , j )} + G [ 2 i + 1 , j ] \} if i < N , \\ 0 if i \geq N \} .$$

The estimated maximum NSE² value is the maximum of two costs calculated for the node's two child subtrees, where each cost sums the estimated maximum NSE² of the subtree and the node's variance divided by the subtree normalization term. While one can easily show that in the optimal solution the maximum NSE² in a subtree will occur for the smallest data value (the proof is based on similar arguments to the single-measure case), the above recurrence is only meant to provide an easy-to-compute estimate for a node's maximum NSE² (under a given space allotment) that GreedyRel can use.

Estimating the Best Marginal Error Gains for Subtrees

Given an error subtree Tᵢⱼ (for the jth measure), the exemplary embodiment of the GreedyRel algorithm computes a subset potSet[i,j] of coefficient values in Tᵢⱼ, which, when allotted additional space, are estimated to provide the largest per=space reduction of the maximum squared NSE over all data values in the Tᵢⱼ subtree. The exemplary embodiments of the algorithms allocate the retention probabilities in multiples of 1/q, where q>1. Let G[i,j] be the current estimated maximum NSE² for Tᵢⱼ (as described above) and let Gₚₒₜ[i,j] denote the potential estimated maximum NSE² for Tᵢⱼ, assuming that the retention probabilities of all coefficient values in potSet[i,j] are increased by a (minimal) additional amount of 1/q. Also, let potSpace[i,j] denote the increase in the overall synopsis size, i.e., the cumulative increase in the space for the corresponding extended coefficients, when allocating the extra space to the coefficient values in potSet[i,j]. The exemplary embodiment of the GreedyRel algorithm computes potSpace[i,j] and estimates the best error-gain subsets potSet[i,j] through the underlying error-tree structure.

Consider a coefficient value Cₖⱼ∈potSet[i,j]. Based on equation (2), it is easy to see that an increase of δ_{y} _{ₖⱼ}in the retention probability of cₖⱼ results in an increase in the expected-space requirement E[[ECₖ]] of the corresponding extended coefficient ECₖ (and, thus, the overall expected synopsis size) of:

$${δ}_{j} ( E 〚 {EC}_{k} 〛 , {δ}_{{y}_{kj}} ) = {δ}_{{y}_{kj}} \cdot ( 1 + H \times {\prod }_{p \neq j} ( 1 - {y}_{kp} ) ) . \qquad ( 4 )$$

The total extra space potSpace[i,j] for all coefficient values in potSet[i,j] can be obtained by adding the results of equation (4) for each of these values (with):

$${δ}_{{y}_{kj}} = \frac{1}{q}$$

$$potSpace [ i , j ] = {\sum }_{{c}_{kj} ∈ potSet [ i , j ]} {δ}_{j} ( E 〚 {EC}_{k} 〛 , \frac{1}{q} ) .$$

The marginal error gain for potSet[i,j] is then simply estimated as gain(potSet[i, j])=(G[i, j]−Gₚₒₜ[i, j])/ potSpace[i, j].

To estimate the potSet[i,j] sets and the corresponding Gₚₒₜ[i,j] (and gain( )) values at each node, GreedyRel performs a bottom-up computation over the error-tree structure. For a leaf coefficient cᵢⱼ, the only possible choice is potSet[i,j]={cᵢⱼ}, which can result in a reduction in the maximum NSE² if cᵢⱼ ≠0 and yᵢⱼ<1 (otherwise, the variance of the coefficient is already 0 and can be safely ignored). In this case, the new maximum NSE² at cᵢⱼ is simply

$${G}_{pot} [ i , j ] = \frac{Var ( {c}_{ij} , {y}_{ij} + \frac{1}{q} )}{Norm ( i , j )} .$$

For a non-leaf coefficient cᵢⱼ, GreedyRel considers three distinct cases of forming potSet[i,j] and selects the one resulting in the largest marginal error gain estimate: (1) potSet[i,j]={cᵢⱼ} (i.e., select only cᵢⱼ for additional storage); (2) potSet[i,j]=potSet[k,j], where k ∈{2i,2i+1} is such that G[i,j]=G[k,j]+Var(cᵢⱼ, yᵢⱼ)/Norm(k,j) (i.e., select the potSet form the child subtree whose estimated maximum NSE² determines the current maximum NSE² estimate at cᵢⱼ); and (3) potSet[ij]=potSet[21j]∪potSet[2i+1,j] (i.e., select the union of the potSets from both child subtrees). Among the above three choices, GreedyRel selects the one resulting in the largest value for gain(potSet[i,j]) and records the choice made for coefficient cᵢⱼ (1, 2, or 3) in a variable chᵢⱼ. In order to estimate gain(potSet[i,j]) for each choice, GreedyRel uses the following estimates for the new maximum NSE² Gₚₒₜ[i,j] at cᵢⱼ] at cᵢⱼ (index k is defined as in case (2) above and I={2i,2i+1}−{k}):

$${G}_{pot} [ i , j ] = \{ max \{ \frac{Var ( {c}_{{i}_{j}} , {y}_{ij} + \frac{1}{q} )}{Norm ( 2 i , j )} + G [ 2 i , j ] , \\ \frac{Var ( {c}_{{i}_{j}} , {y}_{ij} + \frac{1}{q} )}{Norm ( 2 i + 1 , j )} + G [ 2 i + 1 j ] \} {ch}_{ij} = 1 \\ max \{ \frac{Var ( {c}_{ij} , {y}_{ij} )}{Norm ( k , j )} + {G}_{pot} [ k , j ] , \\ \frac{Var ( {c}_{ij} , {y}_{ij} )}{Norm ( l , j )} + G [ l \cdot j ] \} {ch}_{ij} = 2 \\ max \{ \frac{Var ( {c}_{ij} , {y}_{ij} )}{Norm ( 2 i , j )} + {G}_{pot} [ 2 i , j ] , \\ \frac{Var ( {c}_{ij} , {y}_{ij} )}{Norm ( 2 i + 1 , j )} + {G}_{pot} [ 2 i + 1 , j ] \} {ch}_{ij} = 3 \}$$

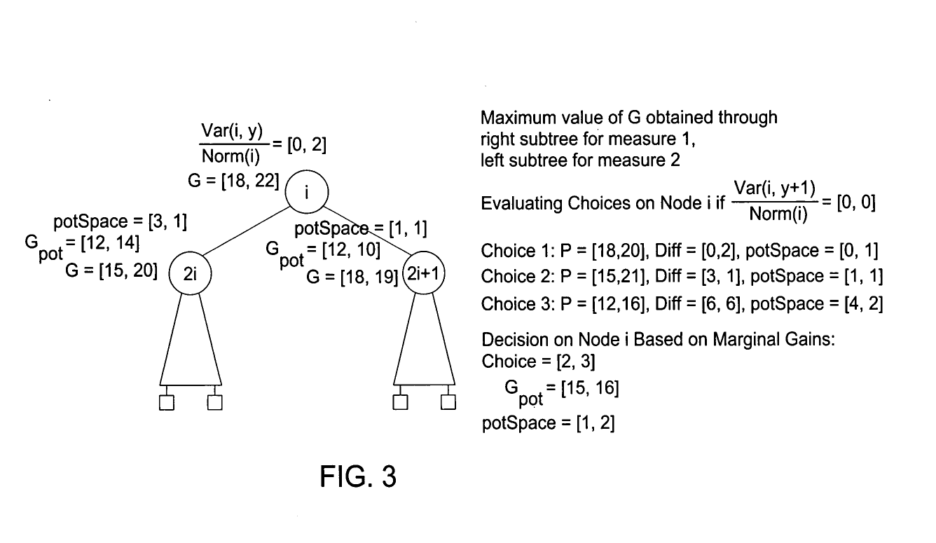

As an example, consider the scenario depicted in FIG. 3 for M =2. FIG. 3 shows, for each of the children of node i, the computed G, Gₚₒₜ, and potSpace values, along with the value of G and the current normalized variance for node i (assume for simplicity that Norm(2i, j) =Norm(2i +1,j)∀j). The three cases of forming potSet for each measure at node i are enumerated, the corresponding potential reductions (Diff) in the estimated maximum NSE² value for each measure are calculated, and the choice that results in the largest per-space reduction is selected for each measure. FIG. 3 also depicts why it is important to simultaneously increase the retention probabilities of more than one coefficient values. At any node i, where the calculated G values through its children are the same, or differ only slightly, for some measure j (as is the case with measure 2 in the example), then any individual assignment of additional space to a coefficient value of that measure below node i would only result in either zero, or very small marginal gains, and would, therefore, not be selected, independently of how much it would reduce the maximum NSE² value through its subtree. This happens because the estimated value of G[i,j] through the other subtree would remain the same. In single-measure data sets the value for G through both subtrees is the same in the optimal solution, thus implying that the above situation is expected to occur very frequently.

Note that GreedyRel does not need to store the coefficient sets potSet[i,j] at each error-tree node. These sets can be reconstructed on the fly, by traversing the error-tree structure, examining the value of the chᵢⱼ variable at each node cᵢⱼ, and continuing along the appropriate subtrees of the node, until reaching nodes with chᵢⱼ=1.

Distributing the Available Synopsis Space

After completing the above described steps, the exemplary embodiment of the GreedyRel algorithm has computed the estimated current and potential maximum NSE² values G[0,j] and Gₚₒₜ[0,j] (along with the corresponding potSet and potSpace) at the root coefficient (node 0) of the error tree, for each data measure j. Because one objective is to minimize the maximum squared NSE among all measures over the entire domain, GreedyRel selects, at each step, the measure jₘₐₓ with the maximum estimated NSE² value at the root node (i.e., jₘₐₓ=arg maxⱼ{G[0,j]}), and proceeds to allocate additional space of potSpace[0,jₘₐₓ] to the coefficients in potSet[0,jₘₐₓ]. This is done in a recursive, top-down traversal of the error tree, starting from the root node and proceeding as follows (i denotes the current node index): (1) chᵢⱼₘₐₓ=1, set

$${y}_{ij max} := {y}_{ij max} + \frac{1}{q} ,$$

(2) if chᵢⱼₘₐₓ=2, then recurse to the child subtree Tₖ, k ∈{2i, 2i+1} through which the maximum NSE² estimate G[i,jₘₐₓ] is computed at node i, and (3) if chᵢⱼₘₐₓ=3, then recurse to both child subtrees T₂ᵢand T₂ᵢ₊₁. Furthermore, after each of the above steps, compute the new G, Gₚₒₜ, potSpace and ch values at node i. These quantities need to be evaluated for all measures, because the space dependencies among the coefficient values, the increase of the coefficient value for measure Jₘₐₓ may alter the ch values for the other measures.
Time and Space Complexity

For each of the N error-tree nodes, the exemplary embodiment of GreedyRel maintains the variables G[i,j], Gₚₒₜ[i,j], potSpace[i,j], and chᵢⱼ. Thus, the space requirements per node are O(M), resulting in a total space complexity of O(NM).

In the bottom-up initialization phase (steps 1-6), GreedyRel computes, for each error-tree node, the values of the G[i,j], Gₚₒₜ[i,j], potSpace[i,j], and chᵢⱼ variables (for each measure j). Each of these O(M) calculations can be done in O(1) time, making the total cost of the initialization phase O(NM). Then, note that each time GreedyRel allocates space to a set of K coefficients, the allocated space is ≧K ×1/q (see equation (4)). To reach these K coefficients, GreedyRel traverses exactly K paths of maximum length O(log N). For each visited node, the new values of G, Gₚₒₜ, potSpace, and ch are computed, which requires O(M) time. Finding the measure jₘₐₓ with the maximum estimated NSE² value at the root requires time O(log M) when using a heap structure to store just the G[0,j] values. Thus, GreedyRel distributes space ≧K×1 /q in time O(KM log N+log M), making the amortized time per-space-quantum 1 /q equal to O(M log N+log M/K)=O(M log N). Because the total number of such quanta that are distributed is Bq, the overall running time complexity of GreedyRel is O(NM+BMq log N).

Finally, exemplary embodiments of the GreedyRel algorithm naturally extend to multiple dimensions with a modest increase of D×2^{D} in its running time complexity. These extensions, along with the extensions of PODP to multiple dimensions are described below. Because the number of non-zero coefficients values in multi-dimensional data sets may be significantly larger than the number of tuples, a thresholding step limits the space needed by the algorithm. This thresholding step can, of course, also be used in the one-dimensional case to further reduce the running time and space requirements of the exemplary embodiment of the GreedyRel algorithm. This step can e performed without introducing any reconstruction bias. Table 2 contains a synopsis of the running time and space complexities of the exemplary embodiment of the GreedyRel algorithm and the MinRelVar algorithm, where N_{z} denotes the number of error-tree nodes containing at least one non-zero coefficient value and maxD denotes the maximum domain size among all dimensions.

TABLE 2
GreedyRel and MinRelVar complexities.

| Algorithm | Space | Running Time |
|---|---|---|
| GreedyRel | O(N_{z}M) | O(D2^{D} × (N_{z}M + BMq log max D)) |
| MinRelVar | O(N_{z}MB2^{D}q) | O(N_{z}BM2^{D} q(q log(qB) + D2^{D})) |

Flow Charts of Exemplary Embodiments

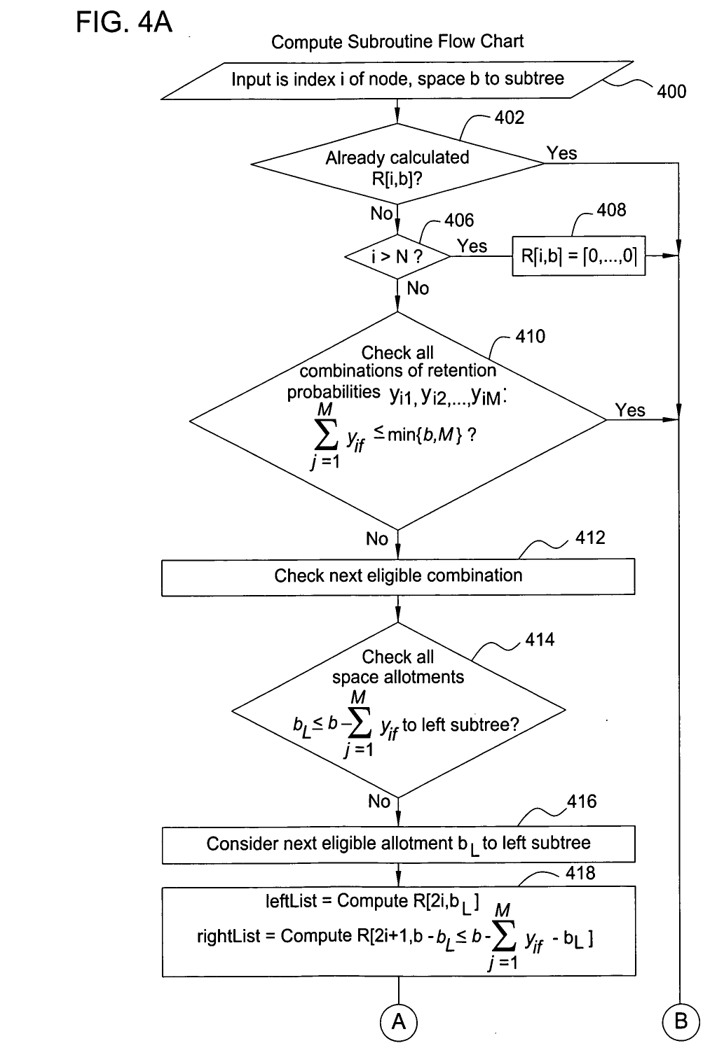

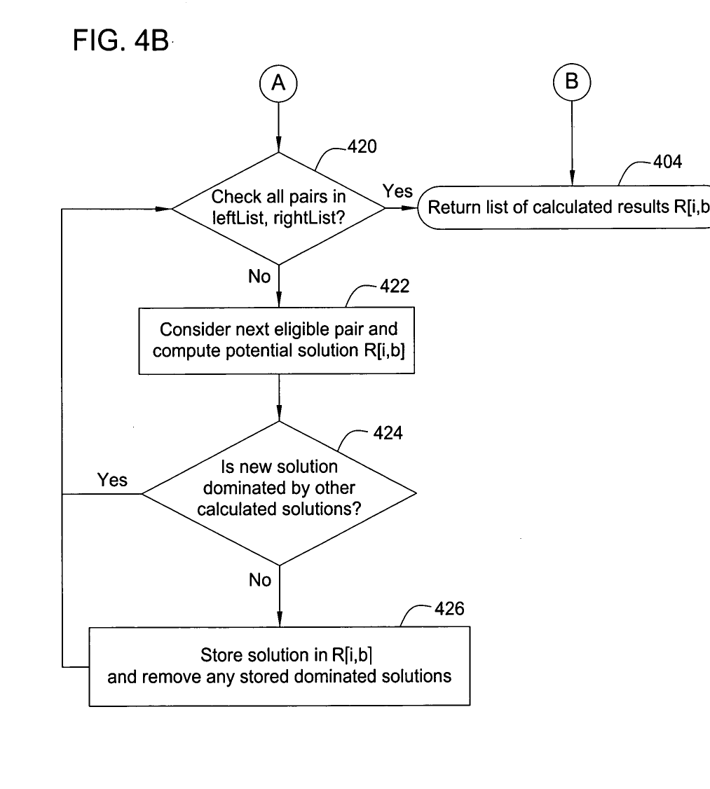

FIGS. 4A and 4B are a flow chart for an exemplary embodiment of a compute subroutine. Input is index i of node, space b to subtree at 400. It is determined whether R[i,b] is already calculated at 402. If so, the list of calculated results R[i,b] is returned at 404. Otherwise, it is determined whether i>N at 406. If so, R[i,b]=[0, . . . ,0 ] and the list of calculated results R[i,b] is returned at 404. Otherwise, it is determined whether all combinations of retention probabilities

$${y}_{i 1} , {y}_{i 2} , … , {y}_{iM} \text{:} {\sum }_{j = 1}^{M} {y}_{ij} \leq min \{ b , M \}$$

have been checked at 410. If so, the list of calculated results R[i,b] is returned at 404. Otherwise, the next eligible combination is checked at 412. It is determined whether all space allotments

$${b}_{L} \leq b - {\sum }_{j = 1}^{M} {y}_{ij}$$

to the left subtree have been checked at 414. If not, the next eligible allotment b_{L} to left subtree is considered at 416 and leftList and rightList are computed, i.e., leftList=ComputeR[2i,b_{L}] and

$$rightList = ComputeR [ 2 i + 1 , b - {b}_{L} \leq b - {\sum }_{j = 1}^{M} {y}_{ij} - {b}_{L} ]$$

at 418. Then, at 420, it is determined whether all pairs in leftList, rightList have been checked. If so, then the list of calculated results R[i,b] is returned at 404. Otherwise, the next eligible pair is considered and the potential solution R[i,b] is computed at 422. Then, it is determined whether the new solution is dominated by other calculated solutions. If so, then control flows back to 420. Otherwise, the solution is stored in R[i,b] and any stored dominated solutions are removed at 426.

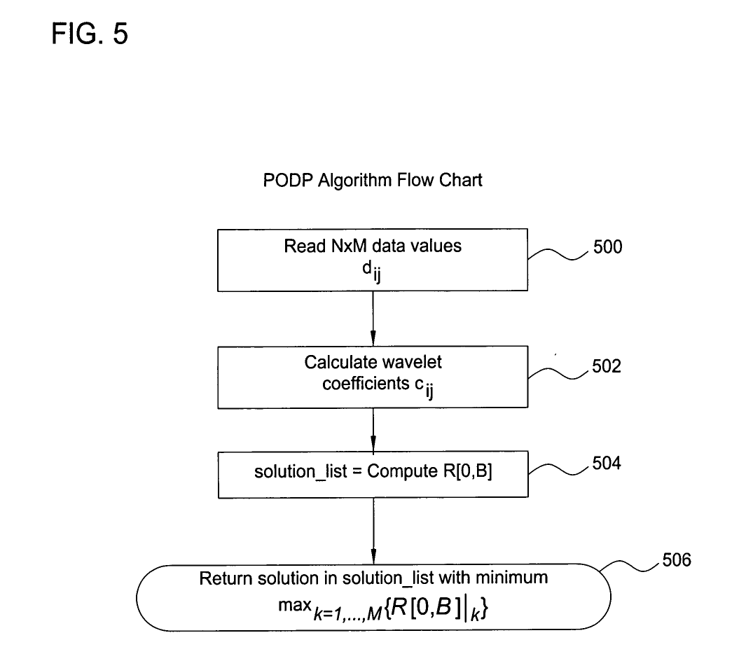

FIG. 5 is a flow chart for an exemplary embodiment of a partial order dynamic programming (PODP) algorithm. N×M data values, dᵢⱼ, are read at 500. Then, wavelet coefficients cᵢⱼ are calculated at 502. A solution list=Compute R[0,B] at 504 and the solution in the solution list is return that has the minimum max_{k=1, . . . , M} {R[0, B]ₖ } at 506.

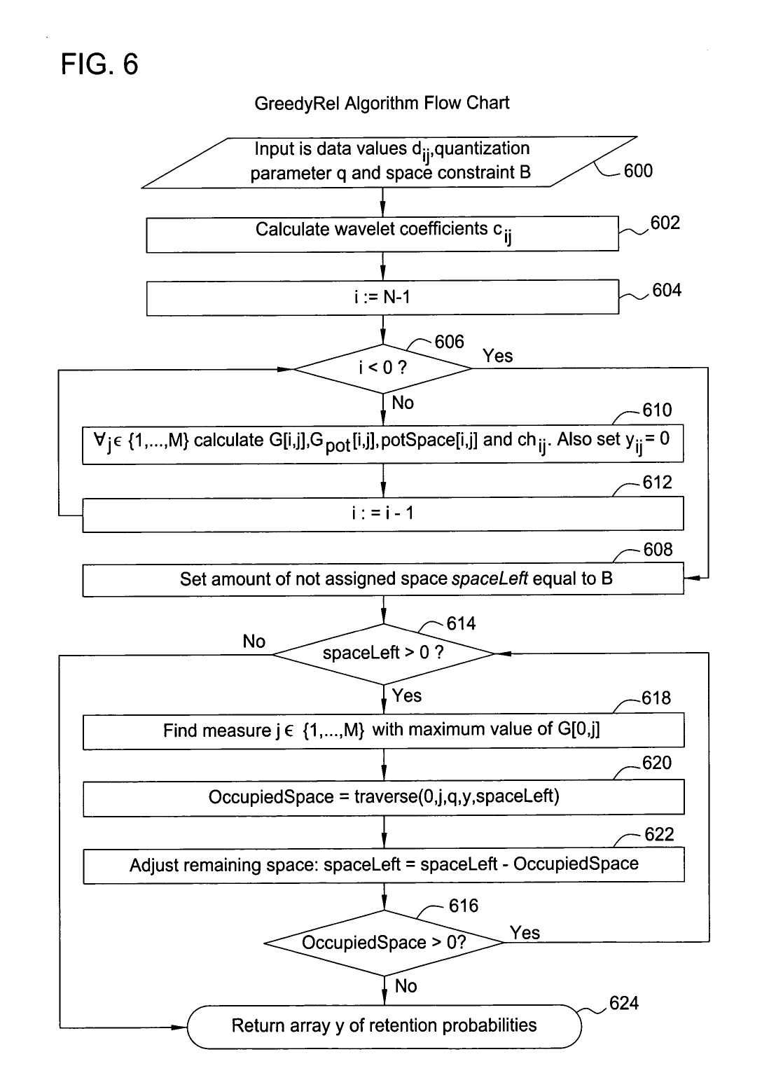

FIG. 6 is a flow chart for an exemplary embodiment of a GreedyRel algorithm. Input data includes data values dᵢⱼ, quantization parameter q and space constraint B at 600. Wavelet coefficients are calculated at 602. Initialization i :=N−1 is performed at 604. A loop at 606 is performed until i<0, when the amount of not assigned space spaceLeft is set equal to B at 608. Inside the loop at 610, ∀j ∈{1, . . . , M} calculate G[i,j], Gₚₒₜ[i,j], potSpace[i,j], and chᵢⱼ and set yᵢⱼ to zero. Then, decrement i at 612.

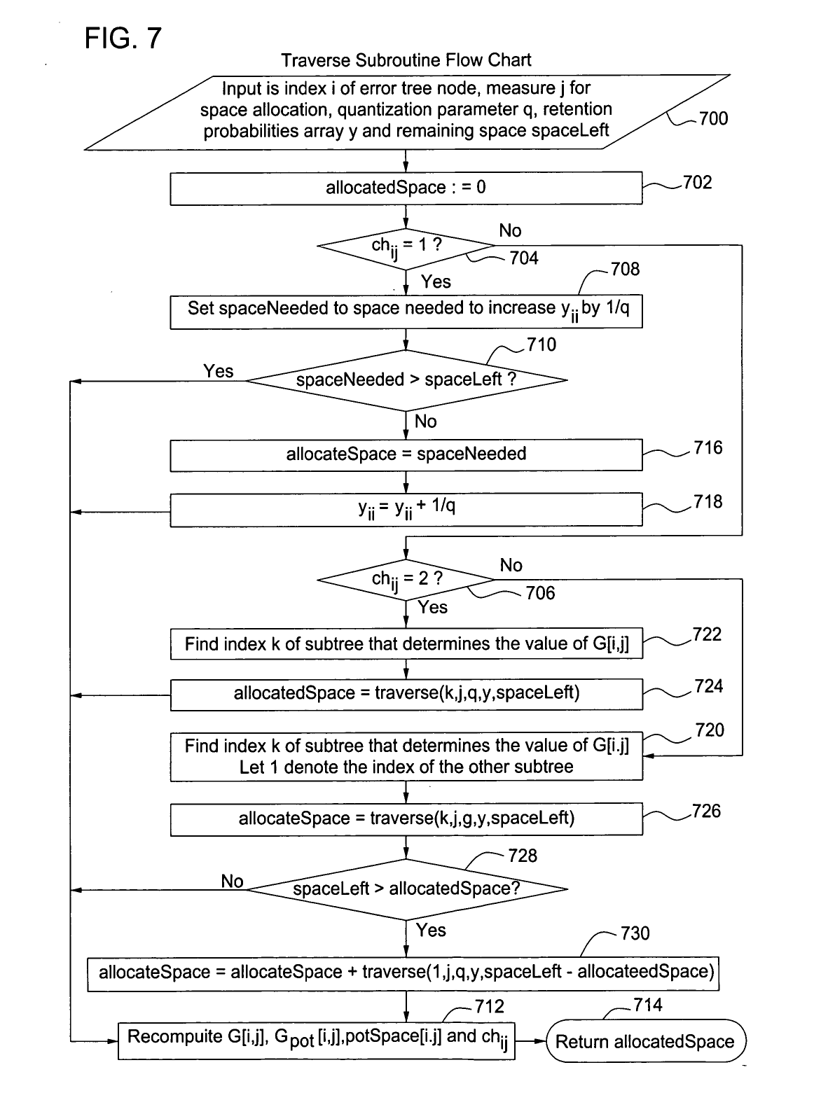

After 608, another loop at 614 is performed until spaceLeft >0, when, if the OccupiedSpace ≦0 at 616, the array y of retention probabilities is returned at 624. Inside the loop at 618, the measure j ∈{1, . . . , M} is found with a maximum value of G[0,j]. Then, OccupiedSpace=traverse(0, j,q,y,spaceLeft) at 620. (See FIG. 7 for the traverse subroutine). The remaining space is adjusted at 622, i.e., spaceLeft=spaceLeft−OccupiedSpace. If the OccupiedSpace ≦0 at 616, the array y of retention probabilities is returned at 624. Otherwise, control flows to the top of the loop at 614.

FIG. 7 is a flow chart of an exemplary embodiment of a traverse subroutine, which is called in the GreedyRel algorithm of FIG. 6. Input to the traverse subroutine at 700 includes index i of the error tree node, the measure j for space allocation, the quantization parameter q, the retention probabilities array y and the remaining space spaceLeft. AllocatedSpace is initialized to zero at 702. At 704, it is determined whether chᵢⱼ=1. If not, control flows to 706; otherwise, if chᵢⱼ=1, control flows to 708. At 708, spaceNeeded is set to the space needed to increase yᵢⱼ by 1/q. It is determined whether the spaceNeeded>spaceLeft at 710. If so, control flows to 712 where G[i, j], Gₚₒₜ[i, j], potSpace[i, j] and chⱼ are recomputed and allocatedSpace is returned at 714. Otherwise, allocatedSpace=spaceNeeded at 716 and yᵢⱼ=yᵢⱼ+1/q at 718 and control flows to 712.

At 706, it is determined whether chᵢⱼ=2. If not, control flows to 720, where index k of the subtree that determines the value of G[i,j] is found and I denotes the index of the other subtree. Otherwise, at 722 index k of the subtree that determines the value of G[i,j] is found and at 724 allocatedSpace=traverse(k,i,q,y,spaceLeft) and, then, control flows to 712.

After 720, where index k of the subtree that determines the value of G[i,j] is found and I denotes the index of the other subtree, allocatedSpace=traverse(k,i,q,y,spaceLeft) at 726. Then, it is determined whether spaceLeft>allocatedSpace at 728. If not, control flows to 712. Otherwise, allocatedSpace =allocatedSpace+traverse(l,j,q,y,spaceLeft−allocatedSpace) at 730 and, then, control flows to 712

At 712, G[i, j], Gₚₒₜ[i, j], potSpace[i, j] and chⱼ are recomputed and allocatedSpace is returned at 714.

Experimental Study

An extensive experimental study was conducted of exemplary embodiments of algorithms for constructing probabilistic synopses over data sets with multiple measures. One objective in the study was to evaluate both the scalability and the obtained accuracy of the exemplary embodiment of the GreedyRel algorithm for a large variety of both real-life and synthetic data sets containing multiple measures.

The study demonstrated that an exemplary embodiment of the GreedyRel algorithm is a highly scalable solution that provides near optimal results and improved accuracy to individual reconstructed answers. This exemplary embodiment of the GreedyRel algorithm provided a fast and highly-scalable solution for constructing probabilistic synopses over large multi-measure data sets. Unlike earlier schemes, such as PODP, this GreedyRel algorithm scales linearly with the domain size, making it a viable solution for large real-life data sets. This GreedyRel algorithm consistently provided near-optimal solutions when compared to PODP, demonstrating that it constitutes an effective technique for constructing accurate probabilistic synopses over large multi-measure data sets. Compared to earlier approaches that operate on each measure individually, this GreedyRel algorithm significantly reduced the maximum relative error of the approximation and, thus, was able to offer significantly tighter error guarantees. These improvements were typically of a factor two, but, in many cases, up to 7 times smaller maximum relative errors were observed.

Experimental Techniques and Parameter Setttings

The experimental study compared an exemplary embodiment of the GreedyRel algorithm and a PODP algorithm for constructing probabilistic data synopses over multi-measure data sets, along with a technique called IndDP that partitioned the available space equally over the measures and, then, operated on each measure individually by utilizing a dynamic programming MinRelVar algorithm. To provide a more fair comparison to the IndDP algorithm, the majority of the experiments included data sets where all the measured quantities exhibited similar characteristics, thus yielding a uniform partitioning of the synopsis space over all the measures as the appropriate space allocation technique. Experiments were also performed with a GreedyL2 algorithm, which is designed to minimize the average sum squared error in multi-measure data sets. However, the GreedyL2 algorithm consistently exhibited significantly larger errors than the exemplary embodiments. A parameter in the exemplary embodiments of the algorithms was the quantization parameter q, which was assigned a value of 10 for the GreedyRel and IndDP algorithms and a smaller value of 4 for the PODP algorithm to reduce its running time. Moreover, the sanity bound of each measure was set to the 5%-quantile value for the measure's data values.

Experimental Data Sets

Several one-dimensional synthetic multi-measure data sets were used in experiments. A Zipfian data generator was used to produce Zipfian distributions of various skews, such as a low skew of about 0.5 to a high skew of about 1.5, with the sum of values for each measure set at about 200,000. Each Zipfian distribution was assigned one of three possible shapes: NoPerm, Normal, or PipeOrgan. NoPerm was the typical Zipfian distribution, where smaller domain values were assigned higher values for the measured quantities. Normal resembled a bell-shaped normal distribution, with higher (lower) values at the center (endpoints) of the domain. PipeOrgan assigned higher (lower) data values to the endpoints (middle) of the domain. In all cases, the centers of the M distributions were shifted and placed in random points of the domain. Also considered were several different combinations of used Zipfian distributions. In an AllNoPerm combination, all M of the Zipfian distributions had the NoPerm shape. Similarly, in an AllNormal combination, all M of the Zipfian distributions had the Normal shape. Finally, in a Mixed combination, ⅓ of the M distributions had the NoPerm shape, ⅓ had the Normal shape, and the remaining ⅓ had the PipeOrgan shape. The results presented are indicative of the multiple possible combinations of the parameters.

In the experimental study, a real-life data set was also used. A weather data set contained meteorological measurements obtained by a station at the University of Washington. This was a one-dimensional data set for which the following six quantities were extracted: wind speed, wind peak, solar irradiance, relative humidity, air temperature, and dewpoint temperature.

Approximation Error Metric

In all cases, the study focused on the maximum relative error of the approximation, because it provided guaranteed error-bounds for the reconstruction of any individual data value and was the error metric that the exemplary embodiments of the algorithms tried to minimize.

Comparing PODP and GreedyRel

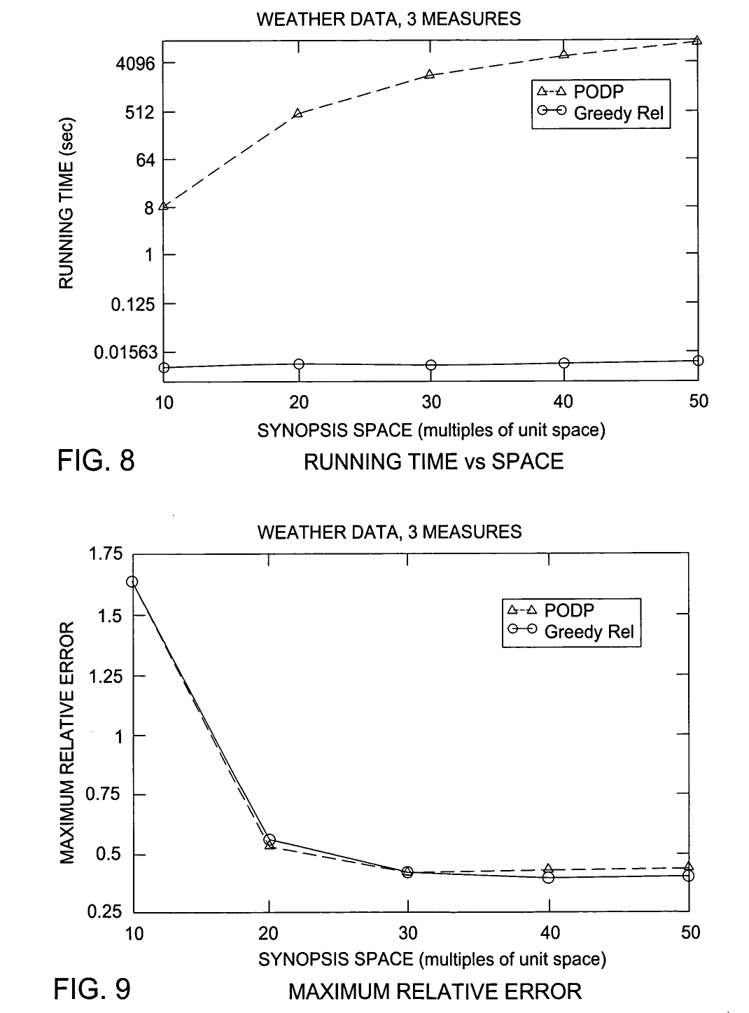

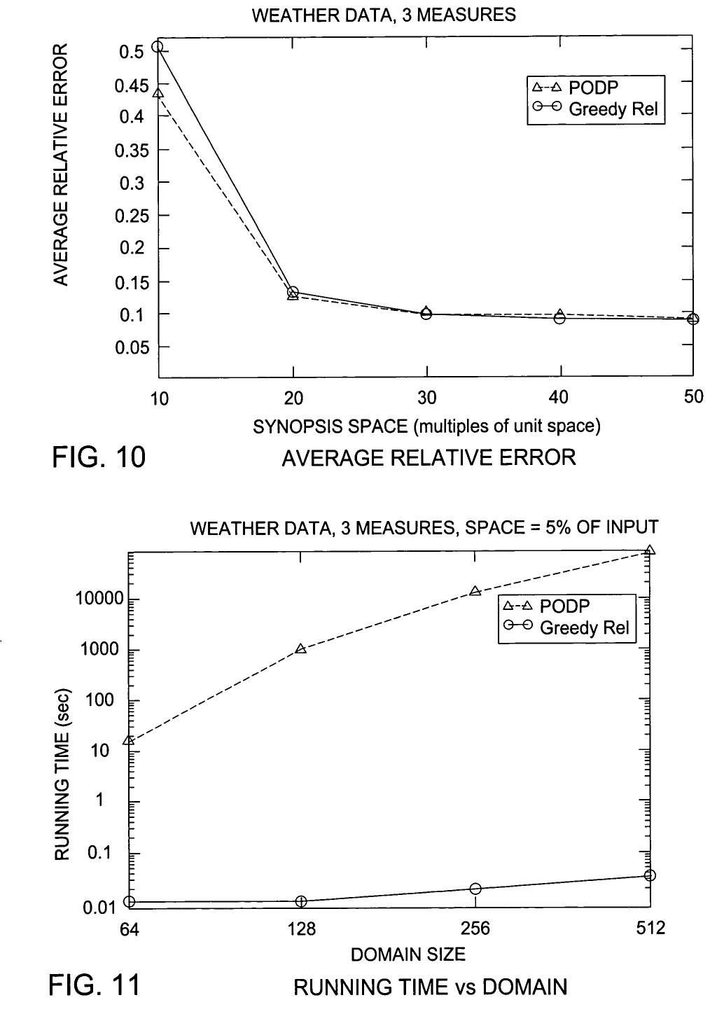

The accuracy and running time of the exemplary embodiment of the GreedyRel algorithm was compared to the PODP algorithm. In FIGS. 8, 9, and 10 the running time and maximum and average relative errors are plotted, correspondingly for the two algorithms and for the weather data set, when the synopsis space was varied from 10 to 50 units of space. The unit of space was the size of each data value, i.e., sizeof(float). In this experiment, only the three most difficult to approximate measures were used. The domain size of the data set was set to 128. In the plots depicting the running time of algorithms, the Y axis is logarithmic. The running time of the PODP algorithm did not scale well with the size of the data synopsis, even for a small data set. For example, for a synopsis size of 50 space units, the PODP algorithm required more than 2 hours to complete, while the GreedyRel algorithm provided near-optimal solutions in all cases.

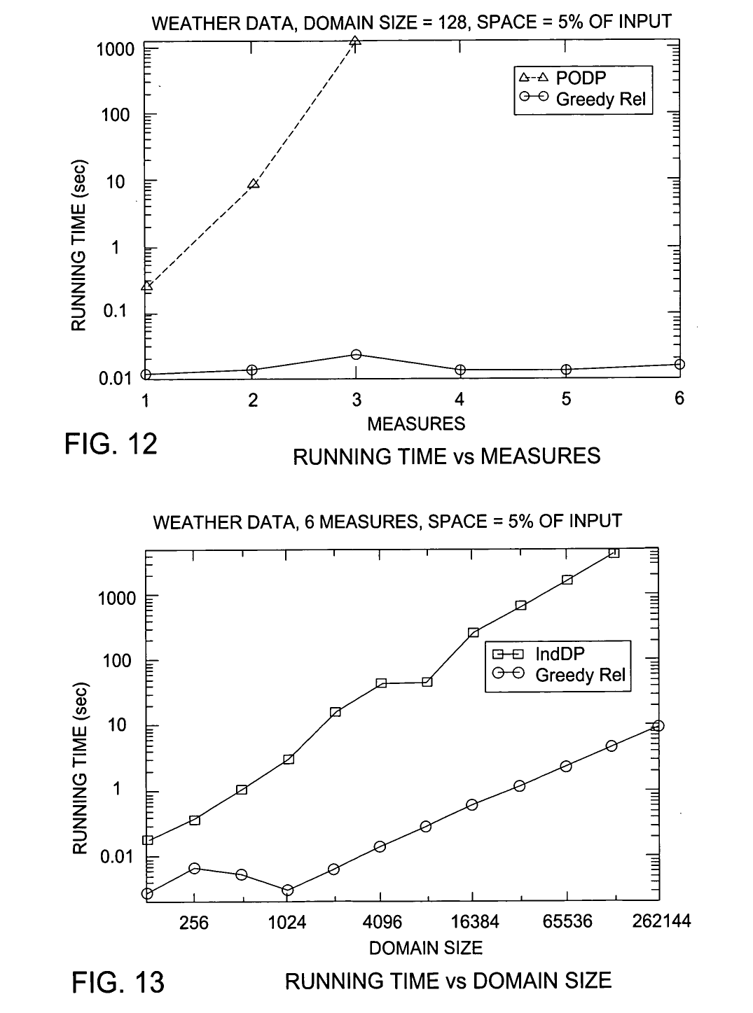

FIG. 11 presents the corresponding running times for both algorithms, as the domain size is increased from 64 to 512. From the weather data set, just three measures were extracted and the synopsis space was always set to be 5% of the size of the input. Again, the running time performance of PODP was disappointing. For a domain size of 512, its running time exceeded 14 hours. Finally, as FIG. 12 demonstrates, the running time of PODP increased exponentially with the number of the data set measures. For data sets with four or more measures, the PODP did not terminate within one day. It is easy to see that the PODP algorithm cannot be used but for toy-like data sets. On the other hand, the GreedyRel algorithm provided near-optimal solutions in all tested cases, while exhibiting small running times.

Running Time Comparison of GreedyRel and IndDP

FIG. 13 is a plot of the running times of the exemplary embodiment of the GreedyRel algorithm and the IndDP algorithm for the weather data set (all 6 measures were included) as the domain size is increased from 128 to 524288. The synopsis size was always set to 5% of the input data. The IndDP algorithm was considerably slower than the GreedyRel algorithm (3 orders of magnitude slower for domain size 131,072) with the difference increasing rapidly with the increase of the domain size. While the GreedyRel algorithm scales linearly with the increase in the domain size (i.e., doubling the domain size doubles the running time), the lndDP algorithm grows much faster every time the domain size is doubled. This, of course, is consistent with the running time complexity of the IndDP algorithm, because when the domain size is doubled, the synopsis space is doubled as well. Moreover, the large memory requirements (O(NBq)) of the IndDP algorithm prevented it from terminating for domain sizes larger than 131,072 (the main memory of the testing machine was 512MB). Thus, the linear scalability of the GreedyRel algorithm to the domain size, in terms of both its running time and its memory requirements, constitutes it as a viable technique for providing tight error guarantees, not only on multi-measure data sets, but also on single-measure data sets, because both the GreedyRel and the lndDP algorithms scale in a similar way for such data sets. Moreover, the GreedyRel algorithm, which utilizes the extended wavelet coefficients to store the selected coefficient values, also outperformed the IndDP algorithm in terms of the obtained accuracy of the data synopsis. The improved accuracy was attributed to the improved storage utilization achieved by using extended wavelet coefficients and the ability of the GreedyRel algorithm to exploit the underlying storage dependencies.

Accuracy Comparison of GreedyRel and IndDP in Synthetic Data Sets.

For the synthetic data sets, a domain size of 256 was used. The obtained accuracy in terms of the maximum error of the approximation for the GreedyRel and the IndDP algorithms and six representative combinations of synthetic data sets is presented. These size combinations arise from considering Zipfian distributions with skew 0.6 and 1, along with the other possible combinations of the used Zipfian distributions (i.e., AllNoPerm, AllNormal, and Mixed). The synthetic data sets in this section contain six measures/distributions.

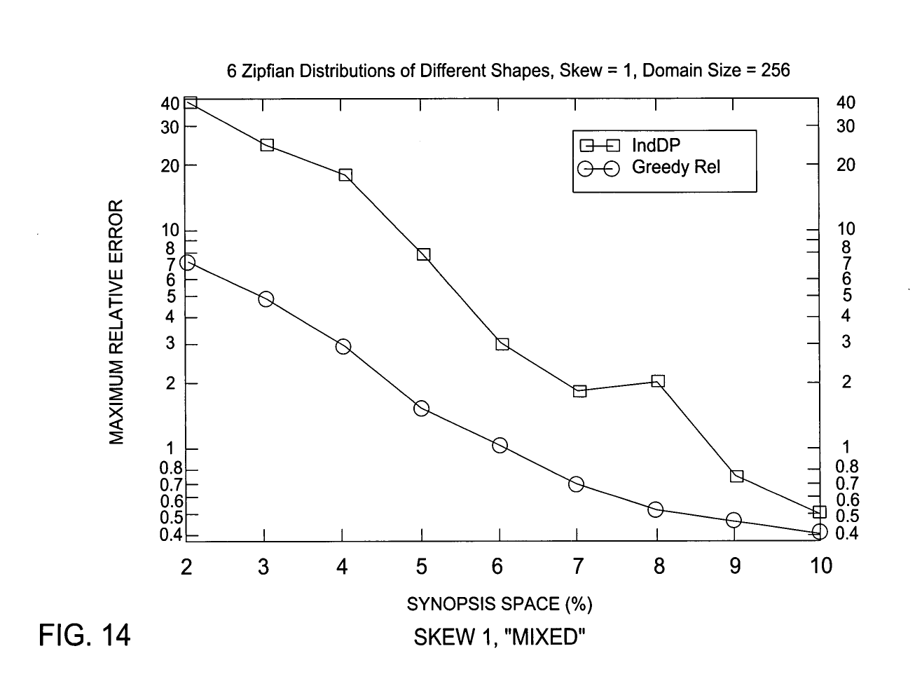

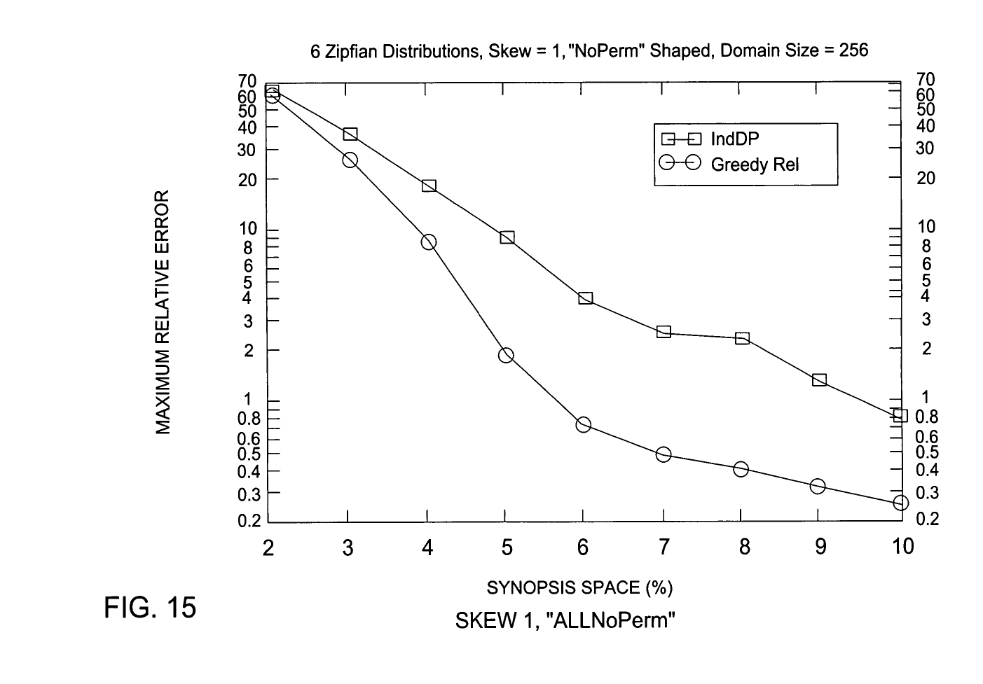

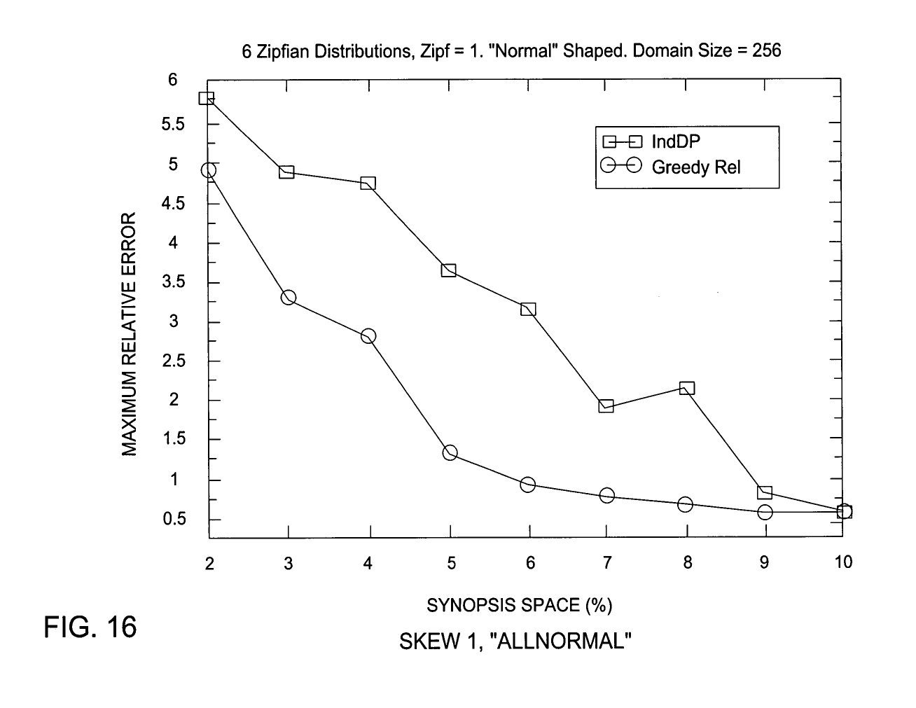

Consider the six possible combinations arising from distributions having skew equal to 1. In FIGS. 14, 15, and 16, the maximum relative errors are plotted for the GreedyRel and IndDP algorithms, as the synopsis space is varied from 2% to 10% of the input data size and for the Mixed, AllNoPerm, and AllNormal (in the specific order) selection of Zipfian distribution shapes. The Y axis for the AllNoPerm and Mixed cases is logarithmic, due to the large maximum errors observed in this case, mainly by the lndDP algorithm. Intuitively, this occurs because the shifting of some distribution centers in this case resulted in the largest values of the data set being adjacent to the smallest values, thus requiring several coefficient values to capture this large difference of the values. As shown, the GreedyRel algorithm provided more accurate results than the lndDP algorithm, with the differences more significant in the AllNoPerm and Mixed cases (Y axis is logarithmic in these two cases). Even though none of the techniques provided right error bounds for such a large data skew value and for small data synopses, the improvements achieved by the GreedyRel algorithm were very significant in each combination of used Zipfian distributions. For each combination, GreedyRel produced, correspondingly up to 6.1, 5.7, and 3.5 times smaller maximum relative errors than IndDP.

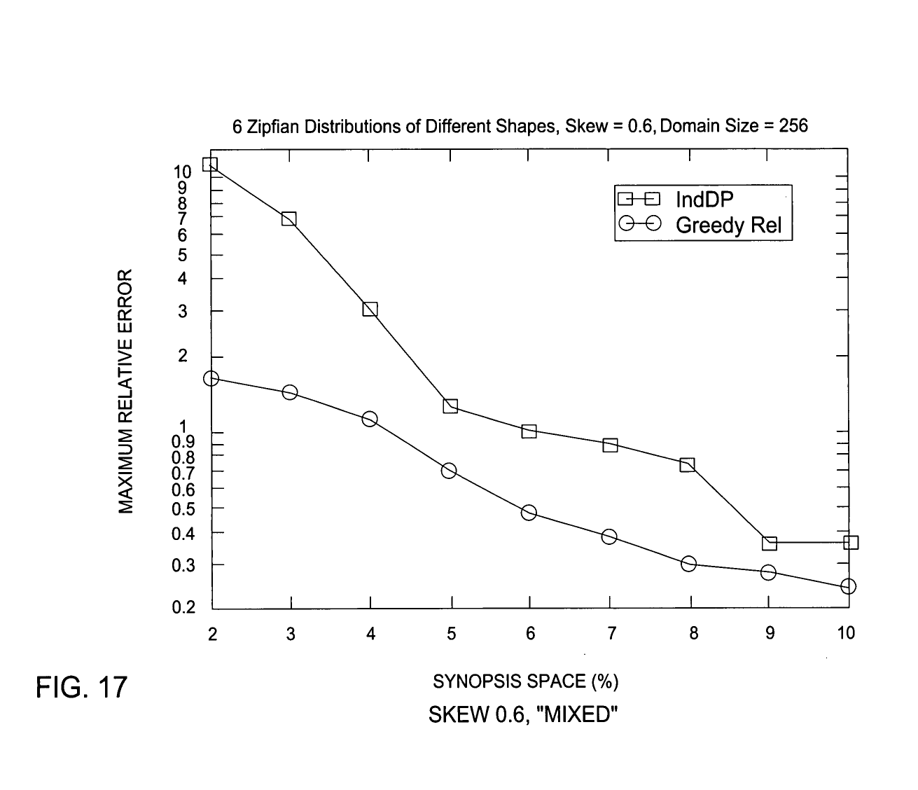

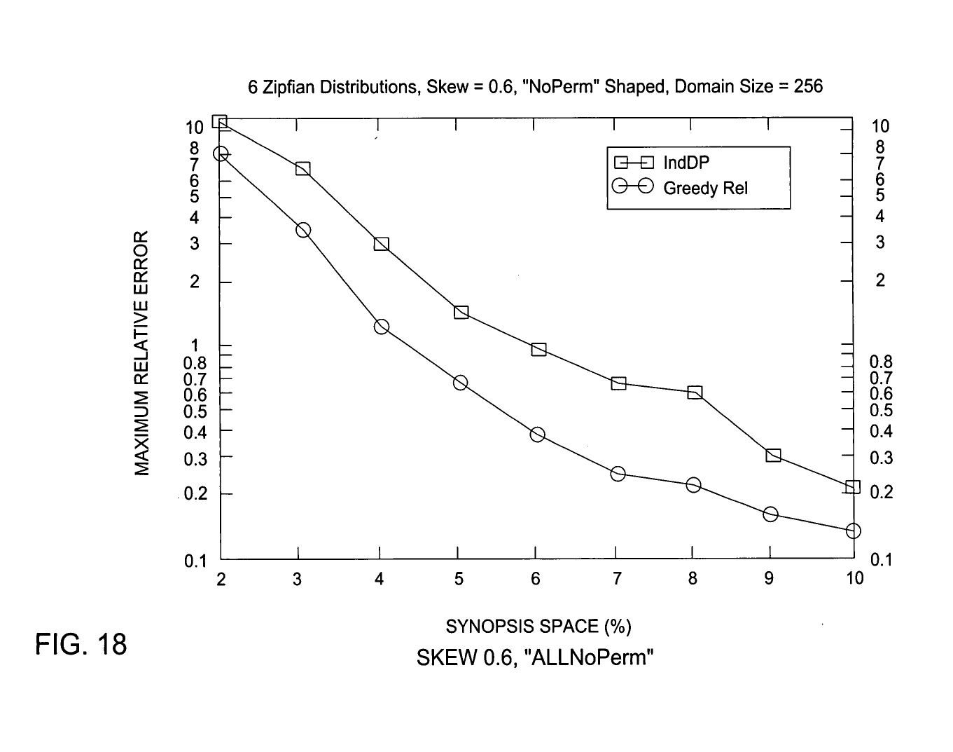

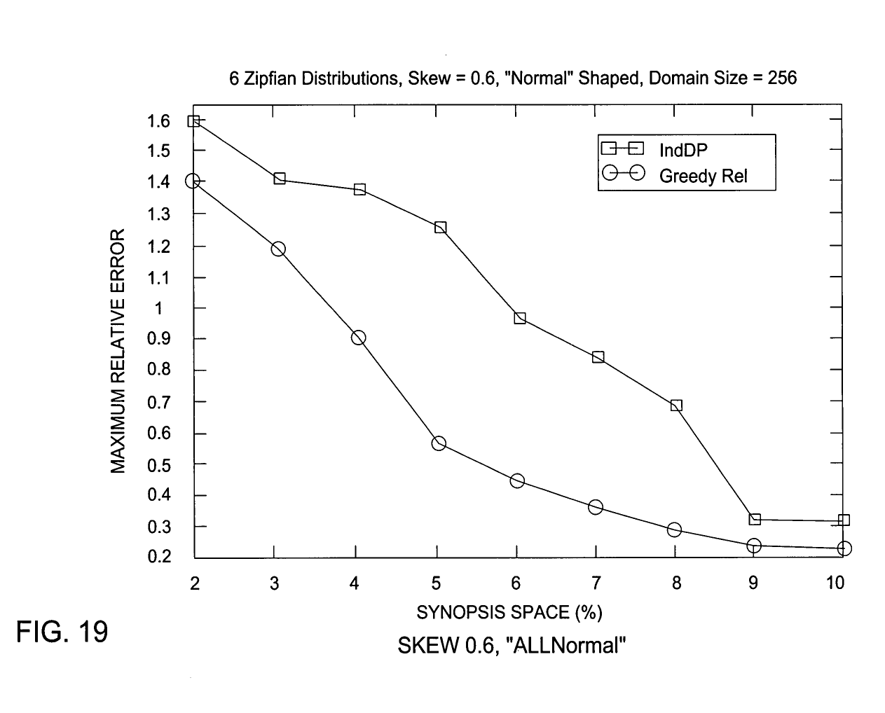

Similar results were also observed for the six combinations of synthetic data sets, arising from setting the skew of the distributions to 0.6. In FIGS. 17, 18, and 19, the corresponding results for the Mixed, AllNoPerm, and AllNormal combinations of used data distributions (logarithmic Y axis in the AllNoPerm and Mixed cases). The maximum relative errors in this case were significantly smaller for all methods. However, the GreedyRel algorithm was still able to provide substantially more tight error bounds, up to 6.9, 2.7, and 2.3 times smaller than IndDP.

Accuracy Comparison of GreedyRel and IndDP in Real Data Sets

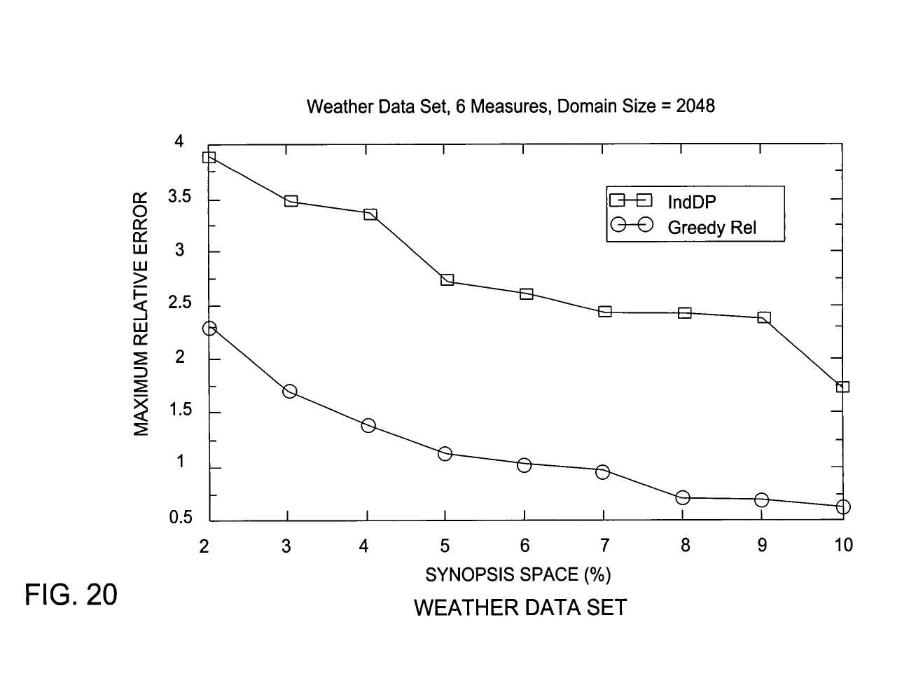

In FIG. 20, the maximum relative errors are plotted for the weather data set, as the size of the synopsis was varied and for domain sizes of 2048 and 1024 respectively. As shown, the benefits of the GreedyRel algorithm continued to be significant in all cases. In the weather data set, the GreedyRel algorithm provided up to 3.5 times tighter error bounds than the IndDP algorithm (and commonly at least a two-fold improvement).

In summary, exemplary embodiments of effective techniques for building wavelet synopses over multi-measure data sets are provided. These techniques seek to minimize, given a storage constraint, the maximum relative error of reconstructing any data value among all measures. The difficulty of the problem compared to the single measure case is demonstrated and a partial-order dynamic programming (PODP) solution is provided. Given the high time and space complexities of PODP, a fast and scalable approximate algorithm is provided that greedily allocates synopsis space based on the idea of marginal error gains. Experimental evaluation demonstrated that the GreedyRel algorithm exhibited near-optimal solutions, while, at the same time, outperformed prior techniques based on optimizing each measure independently. GreedyRel is a viable solution, even in the single-measure case, for constructing accurate probabilistic wavelet synopses over large data sets.

Pseudo Code for GreedyRel Algorithm

Table 1 below shows pseudo code for an exemplary embodiment of the GreedyRel algorithm. In the later steps of this algorithm, the available synopsis space may become smaller than potSpace[i, jₘₐₓ]; in this case, rather than recursing on both child subtrees of a node (when chᵢⱼₘₐₓ=2), this algorithm first recurses on the child causing the maximum estimated squared NSE, and then recurses on the other child with any remaining space (steps 12-16 of traverse).

TABLE 1
Pseudo Code for GreedyRel Algorithm

procedure GreedyRel(W_{A},B,q,s)
Input: N × M array W_{A} of Haar wavelet coefficients; space constraint B;

quantization parameter q > 1; vector of per-measure sanity bounds s.

```
Output: Array y of retention probabilities yij for all N × M coefficients.
begin
  1. for i := N − 1 downto 0 do // traverse error tree bottom-up
  2. for j := 1 to M do
```

| | |
|---|---|
| 3. | yᵢⱼ = 0 |
| 4. | Compute G[i,j], Gₚₒₜ[i,j], potSpace[i,j], and chᵢⱼ |

```
  5. endfor
  6. endfor
  7. spaceLeft = B
  8. while ( spaceLeft > 0 ) do
  9. jₘₐₓ := arg maxⱼ{G[0,j]}
10. occupiedSpace := traverse(0, jₘₐₓ, q, y, spaceLeft)
11. spaceLeft := spaceLeft − occupiedSpace
12. if (occupiedSpace = 0) then return(y) // not enough space
13. endwhile
14. return(y)
end
procedure traverse(i, j, q, y, spaceLeft)
Input: Index i of error-tree node; measure j chosen for space allocation;
```

quantization parameter q; array y of current retention probabilities;
maximum synopsis space to allocate (spaceLeft).

```
Output: Space allocated to the Tᵢⱼ subtree at this step.
begin
  1. allocatedSpace := 0
  2. if ( chᵢⱼ = 1 ) then
  3. neededSpace := δⱼ(E [symbol] ECᵢ [symbol] ,1/q) // see equation (4)
  4. if ( neededSpace ≦ spaceLeft) then
  5. yᵢⱼ := yᵢⱼ + 1/q
  6. allocatedSpace := neededSpace
  7. endif
  8. else if ( chᵢⱼ = 2 ) then
  9. Find index k of child subtree through which G[i,j] occurs
10. allocatedSpace := traverse(k, j, q, y, spaceLeft)
11. else
12. Find index k of child subtree through which G[i,j] occurs
13. Let I be the index of the other subtree
14. allocatedSpace := traverse(k, j, q, y, spaceLeft)
15. if ( spaceLeft > allocatedSpace ) then
```

| | |
|---|---|
| 16. | allocatedSpace <= traverse(I, j, q, y, spaceLeft-allocatedSpace) |

17. endif
18. Recompute the node's G, Gₚₒₜ, potSpace, and ch values
19. return( allocatedSpace )
end

Extensions to Multi-Dimensionsal Wavelets

Exemplary embodiments of the present invention extend to multi-dimensional data. For a D-dimensional data set, the error-tree structure becomes significantly more complex. Each node in the error tree (besides the root node) corresponds to a set of (at most) 2^{D}−1 wavelet coefficients with the same support region, but different signed contributions for each region quadrant. Furthermore, each error-tree node i (besides the root node) may have up to 2^{D} children, corresponding to the quadrants of the common support region for all coefficients in i.

Extending PODP

Exemplary embodiments of the PODP algorithm for multi-dimensional data sets generalize the corresponding multi-dimensional MinRelVar strategy in a way analogous to the one-dimensional case. PODP needs to consider, at each internal node of the error tree, the optimal allocation of space to the <2^{D}−1 wavelet coefficients of the node and its <2^{D} child subtrees. The extension of PODP to multi-dimensional data sets is therefore a fairly simple adaptation of the multi-dimensional MinRelVar algorithm. However, PODP needs to maintain, for each node i and each possible space allotment B, a collection R[i,B] of incomparable solutions. This, once again, makes the time/space requirements of PODP significantly higher than those of MinRelVar.

Extending GreedyRel

The first modification involved in extending an exemplary embodiment of the GreedyRel algorithm to multi-dimensional data sets has to do with the computation of G[i,j], which now involves examining the estimated NSE² values over <2^{D} child subtrees and maintaining the maximum such estimate. Let S(i) denote the set of the <2^{D}−1 coefficients of nod i and let iₗ, . . . ,iₚ be the indexes of i's child nodes in the error tree. Then,

$$G [ i , j ] = \{ max \{ {\sum }_{{c}_{k} ∈ S ( i )} \frac{Var ( {c}_{kj} , {y}_{kj} )}{Norm ( {i}_{1} , j )} + G [ {i}_{1} , j ] , i < N {\sum }_{{c}_{k} ∈ S ( i )} \frac{Var ( {c}_{kj} , {y}_{ij} )}{Norm ( {i}_{p} , j )} + G [ {i}_{p} , j ] , \} 0 , i \geq N \}$$

Another modification involves the estimation of marginal error gains at each node. A total of three possible choices for forming potSet[i,j] for each (node, measure) combination were described above. Each node has up to 2^{D} child subtrees, resulting in a total of ₂D+1 possible choices of forming potSetOi,j]. The first choice is to increase the retention probability for measure j of one of the <2^{D}−1 coefficients in node i. In this case, include in potSet[i,j] the coefficient in node i that is expected to exhibit the largest marginal gain for measure j. For each of the remaining 2^{D} possible choices of forming potSet[i,j], the k^{th} choice (1<k<2^{D}) considers the marginal gain of increasing the retention probabilities in the child subtrees through which the k maximum NSE² values occur, as estimated in the right-hand side of the above equation for G[i,j]. At each node, the computation of Gₚₒₜ[i,j], potSpace[i,j], and chᵢⱼ incurs a worst-case time cost of O(D×2^{D}) due to the possible ways of forming potSet[i,j] and the sorting operation of 2^{D} quantities. Let N denote the total number of cells in the multi-dimensional data array and maxD denote the maximum domain size of any dimension. Then, the running time complexity of GreedyRel becomes O(D×2^{D}×(NM+BMqlogmax D)). Of course, in most real-life scenarios using wavelet-based data reduction, the number of dimensions is typically a small constant (e.g., 4-6) and the number of tuples can be exponential (O(N^{D})) to the maximum domain size N.

Improving the Complexity of GreedyRel

In the wavelet decomposition process of a multi-dimensional data set, the number of non-zero coefficients produced may be significantly larger than the number N_{z} of non-zero data values. One adaptive coefficient thresholding procedure retains at most N_{z} wavelet coefficients without introducing any reconstruction bias. Using this procedure, the MinRelVar algorithm can be modified so that its running time and space complexity have a dependency on N_{z} and not on N (i.e., the total number of cells in the multi-dimensional data array). It is thus be desirable if to modify the GreedyRel algorithm in a similar way, in order to decrease its running time and space requirements.

Let N_{z} denote the number of error tree nodes that contain non-zero coefficient values, possibly after the afore-mentioned thresholding process. For any node in the error tree containing zero coefficient values that was at most one node in its subtree and does not contain non-zero coefficient values, no computation is needed. Equivalently, exemplary embodiments of the algorithm computes G, Gₚₒₜ values in: nodes containing non-zero coefficient values or nodes that contain zero coefficient values, but which are the least common ancestor of at least two non-zero tree nodes beneath it in the error tree.

Let k be a node that is the only node in its subtree with non-zero coefficient values. The G, Gₚₒₜ values in the descendant nodes of k do not need to be considered, because they will be zero. An observation is that for any ancestor of k that contains just a single, non-zero error tree beneath it (which is certainly the subtree of node k), no computation is necessary, because the G, Gₚₒₜ values of k can be used instead. An additional computation is needed in any node n with zero-coefficients that has at least two non-zero error tree nodes beneath them in the error tree (in different subtrees). In this case, the G, Gₚₒₜ values of node n needs to be calculated, using as input the G, Gₚₒₜ values of its non-zero descendant tree nodes. It is easy to demonstrate that at most N_{z}−1 such nodes may exist. Thus, the GreedyRel algorithm needs to calculate the G, Gₚₒₜ values in at most 0(2N_{z}−1)=O(N_{z}) nodes, thus yielding running time and space complexities of O(D×2D×(N_{z}M+BMqlogmaxD)) and O(N_{Z}M) respectively. In order to implement the algorithm as described, the N_{z} coefficients needs to be sorted based on their postorder numbering in the error tree. This requires an additional O(Nz log Nz) time for the sorting process. However, this running time is often significantly smaller than the benefits of having running time and space dependencies based on N_{z}, rather than on N.

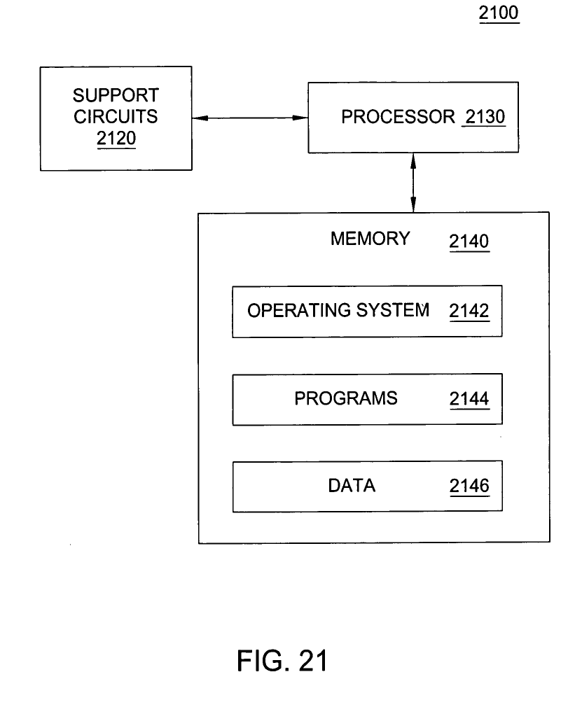

FIG. 21 is a high-level block diagram showing a computer. The computer 2100 may be employed to implement embodiments of the present invention. The computer 2100 comprises a processor 2130 as well as memory 2140 for storing various programs 2144 and data 2146. The memory 2140 may also store an operating system 2142 supporting the programs 2144.

The processor 2130 cooperates with conventional support circuitry such as power supplies, clock circuits, cache memory and the like as well as circuits that assist in executing the software routines stored in the memory 2140. As such, it is contemplated that some of the steps discussed herein as software methods may be implemented within hardware, for example, as circuitry that cooperates with the processor 2130 to perform various method steps. The computer 2100 also contains input/output (I/O) circuitry that forms an interface between the various functional elements communicating with the computer 2100.

Although the computer 2100 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for probabilistic wavelet synopses for data sets with multiple measures, comprising:
constructing, in response to a request, a wavelet synopsis that minimizes an error metric for a data domain having multiple measures, the wavelet synopsis including extended wavelet coefficients;
allocating space by applying a probabilistic thresholding technique that is based on unbiased randomized rounding of the extended wavelet coefficients, the probabilistic thresholding including accounting for storage dependencies among the extended wavelet coefficients and selecting rounding values such that the error metric is minimized, while not exceeding a prescribed space limit for the probabilistic wavelet synopsis; and
providing an approximation in response to the request.

2. The method of claim 1, wherein the approximation includes estimates of all individual data values.

3. The method of claim 1, wherein the error metric is a maximum relative error.

4. The method of claim 3, wherein the maximum relative error is bound to provide an error guarantee on each reconstructed data value.

5. The method of claim 1, further comprising:
formulating dynamic-programming recurrences over a Haar error tree to minimize the error metric.

6. The method of claim 5, further comprising:
assigning retention probabilities to non-zero coefficients within the prescribed space limit by exploiting the error tree structure of a Haar decomposition and the storage dependencies among the extended wavelet coefficients.

7. The method of claim 1, further comprising:
quantizing the space allotments.

8. A method for probabilistic wavelet synopses for multiple measures, comprising:
allocating a synopsis space to extended wavelet coefficients in an error tree based on marginal error gains by, at each step, attempting to allocate additional space to a subset of the extended wavelet coefficients that results in a reduction in a maximum normalized standard error (NSE²) per unit of space used;
computing estimated current and potential maximum NSE² values at a root coefficient of the error tree for each data measure; and
providing an approximation to a maximum minimization problem for the extended wavelet coefficients.

9. The method of claim 8, wherein allocating further comprises:
estimating the maximum NSE² per-unit space values at any node of the error tree;
estimating a best marginal error gain for any subtree by identifying a subset of extended wavelet coefficients that are expected to give a largest per-unit space reduction in the maximum NSE²; and
allocating additional synopsis space to a best overall subset of extended coefficients in the error tree.

10. The method of claim 8, further comprising:
performing a recursive, top-down traversal of the error tree.
